(19) United States
(12) Patent Application Publication
(10) Pub. No.: US 2012/0169716 A1
(43) Pub. Date: Jul. 5, 2012

(54) STORAGE MEDIUM HAVING STORED THEREIN A DISPLAY CONTROL PROGRAM, DISPLAY CONTROL APPARATUS, DISPLAY CONTROL SYSTEM, AND DISPLAY CONTROL METHOD

(75) Inventor: Ichirou MIHARA, Shinagawa-ku (JP)

(73) Assignee: NINTENDO CO., LTD., Kyoto (JP)

(21) Appl. No.: 13/080,896

(22) Filed: Apr. 6, 2011

(30) Foreign Application Priority Data
Dec. 29, 2010 (JP) 2010-294484

(51) Int. Cl. G06T 15/00

(52) U.S. Cl. 345/419

(57) ABSTRACT

Object positioning means positions a first object at a position at a first depth distance in a depth direction in a virtual world. Stereoscopic image output control means outputs as a stereoscopic image the object in the virtual world positioned by the object positioning means. The object positioning means positions at least one second object, at a position at a depth distance which is different from the first depth distance in the depth direction in the virtual world in a manner such that the second object is displayed on at least a part of a display area corresponding to an edge of a display device when the second object is displayed as the stereoscopic image on the display device.

### CROSS REFERENCE TO RELATED APPLICATION

The disclosure of Japanese Patent Application No. 2010-294484, filed on Dec. 29, 2010, is incorporated herein by reference.

### BACKGROUND OF THE INVENTION

1. Field of the Invention

The present invention relates to a storage medium having stored therein a display control program, a display control apparatus, a display control system, and a display control method, and more particularly to a storage medium having stored therein a display control program, a display control apparatus, a display control system, and a display control method for outputting a stereoscopically visible image.

2. Description of the Background Art

Conventionally, a method for displaying a stereoscopically visible image by using images each having a predetermined parallax as disclosed in, for example, Japanese Laid-Open Patent Publication No. 2004-145832 (hereinafter referred to as Patent Literature 1). In a content creation method disclosed in Patent Literature 1, each of figures drawn on an xy plane is assigned a depth in the z-axis direction and is stereoscopically displayed based on the assigned depth. In the method disclosed in Patent Literature 1, for example, an amount of displacement between an image for a right eye and an image for a left eye is calculated with respect to the figures present on each xy plane. In the method, the image for a left eye and the image for a right eye are generated based on the calculated amount of displacement and displayed respectively on a display device.

However, in the method disclosed in Patent Literature 1, it is difficult to perform a stereoscopic display which provides a great sense of depth to each figure.

### SUMMARY OF THE INVENTION

Therefore, a main object of the present invention is to provide a storage medium having stored therein a display control program, a display control apparatus, a display control method, and a display control system capable of emphasizing a sense of depth when outputting a stereoscopically visible image.

In order to achieve the above object, the present invention has, for example, the following features. It should be understood that the scope of the present invention is interpreted only by the scope of the claims. In event of any conflict between the scope of the claims and the scope of the description in this section, the scope of the claims has priority.

An example of a computer-readable storage medium having stored therein a display control program of the present invention causes a computer of a display control apparatus which outputs a stereoscopically visible image to function as object positioning means and stereoscopic image output control means. The object positioning means positions a first object at a position at a first depth distance in a depth direction in a virtual world. The stereoscopic image output control means outputs as a stereoscopic image an object in the virtual world positioned by the object positioning means. The object positioning means positions at least one second object: at a position at a depth distance which is different from the first depth distance in the depth direction in the virtual world; and in a manner such that the second object is displayed on at least a part of a display area corresponding to an edge of a display device when the second object is displayed as the stereoscopic image on the display device.

According to the above, when the first object is outputted as a stereoscopic image, the second object which is positioned at a different depth distance in a depth direction of a virtual world displayed on a display device is displayed in a manner such that the second object is displayed at a position that includes at least a part of an edge of a display screen of the display device. Accordingly, when the user views the position in the depth direction of the first object displayed on the display device, the second object is displayed as a comparison target in the depth direction, thereby emphasizing a sense of depth when the first object is displayed on the display device as the stereoscopic image.

Further, the object positioning means may further position a third object at a position at a second depth distance which is different from the first depth distance in the depth direction in the virtual world. In this case, the object positioning means positions the second object at a position at a depth distance between the first depth distance and the second depth distance in the depth direction in the virtual world.

According to the above, when the first object and the third object at depth distances different from each other are displayed on the display device as the stereoscopic image, the second object is displayed at a position at a depth distance between the depth distance of the first object and the depth distance of the third object in the depth direction in the virtual world displayed on the display device. Accordingly, when the user views the positions in the depth direction of the first object and the third object displayed on the display device, the second object is displayed between the first object and the third object as a comparison target in the depth direction, thereby emphasizing a sense of depth when the first object and the third object are displayed on the display device as the stereoscopic image.

Further, the object positioning means may position the second object in a manner such that the second object is displayed on only the part of the display area corresponding to the edge of the display device.

According to the above, the second object is displayed only at an edge of the display area, and thus there is less chance that the first object and/or the third object displayed on the display device are hidden from view by the second object, thereby improving the visibility of the first object and/or the third object.

Further, the second depth distance may be longer than the first depth distance. In this case, the object positioning means may position the third object in a manner such that the third object does not overlap the second object when the third object is displayed as the stereoscopic image on the display device.

According to the above, the third object displayed at a position farther than the second object in the depth direction is not hidden from view by the second object, and thus visibility of the third object can be secured.

Further, the object positioning means may position a plurality of the second objects: at a position at the depth distance between the first depth distance and the second depth distance; and in a manner such that the plurality of the second objects are always displayed on at least the part of the display area corresponding to the edge of the display device.

According to the above, a plurality of the second objects are displayed as comparison targets in the depth direction, thereby emphasizing a sense of depth when the first object is displayed on the display device as a stereoscopic image.

Further, the object positioning means may: position the plurality of the second objects at positions at different depth distances between the first depth distance and the second depth distance; and display the plurality of the second objects so as to at least partly overlap one another when the plurality of the second objects are displayed as the stereoscopic image on the display device.

According to the above, a plurality of the second objects which are comparison targets are displayed at a plurality of levels at different depth distances in the depth direction in a manner such that the plurality of the second objects overlap one another, thereby emphasizing a sense of depth when the first object is displayed on the display device as a stereoscopic image.

Further, the object positioning means may position: the first object on a plane set at the first depth distance in the virtual world; a third object on a plane set at the second depth distance in the virtual world; and the second object on at least one plane set at a depth distance between the first depth distance and the second depth distance in the virtual world.

According to the above, virtual objects are positioned on planes set at different depth distances in a virtual world, thereby facilitating display of the virtual world in which the plurality of virtual objects move on the different planes as a stereoscopic image.

Further, the display control program may further cause the computer to function as operation signal obtaining means and first object motion control means. The operation signal obtaining means obtains an operation signal corresponding to an operation performed onto an input device. The first object motion control means causes the first object to perform a motion in response to the operation signal obtained by the operation signal obtaining means. In this case, the second object may be a virtual object which affects a score which the first object obtains in the virtual world and/or a time period during which the first object exists in the virtual world. The third object may be a virtual object which affects neither the score which the first object obtains in the virtual world nor the time period during which the first object exists in the virtual world.

According to the above, the present invention is appropriate for reforming a game (game in which a two-dimensional image is displayed, for example) in which virtual objects which affect a game play or a game progress are positioned at two depth areas, respectively, into a game in which a stereoscopic image can be displayed as well as a two-dimensional image. For example, a virtual object which affects neither a game play nor a game progress is positioned between two virtual objects which affect the game play or the game progress, thereby allowing stereoscopic display with an emphasized sense of depth between the two virtual objects which affect the game play or the game progress.

Further, the stereoscopic image output control means may output the stereoscopic image while scrolling, in a predetermined direction perpendicular to the depth direction, each of the objects positioned by the object positioning means. The object positioning means may position the second objects in a manner such that the second objects are always displayed on at least a part of the display area corresponding to both edges of the display device opposite to each other along the predetermined direction when the second objects are displayed as the stereoscopic image on the display device.

According to the above, even when virtual objects are scroll-displayed on a display device, the second objects can be always displayed on at least a part of both edges of a display screen of the display device.

Further, the stereoscopic image output control means may output the stereoscopic image while scrolling, in the predetermined direction perpendicular to the depth direction, the objects positioned by the object positioning means by different amounts of scroll in accordance with the depth distances.

According to the above, virtual objects at different depth distances are scroll-displayed at different scroll speeds, respectively, thereby further emphasizing a sense of depth of the virtual objects which are stereoscopically displayed.

Further, the stereoscopic image output control means may set an amount of scroll of the second object so as to be smaller than an amount of scroll of the first object and larger than an amount of scroll of the third object.

According to the above, a scroll speed of the second object positioned at a level between the first object and the third object is set so as to be lower than a scroll speed of the first object and higher than a scroll speed of the third object, thereby further emphasizing a sense of depth of the first to the third objects which are stereoscopically displayed.

Further, the object positioning means may position a plurality of the second objects at positions at different depth distances between the first depth distance and the second depth distance. The stereoscopic image output control means may output the stereoscopic image while scrolling, in a predetermined direction, the plurality of the second objects by different amounts of scroll in accordance with the depth distances.

According to the above, scroll speeds of a plurality of the second objects positioned respectively on a plurality of levels between the first object and the third object are set so as to be different from each other, thereby further emphasizing a sense of depth of the first to third objects which are stereoscopically displayed.

Further, the stereoscopic image output control means may output the stereoscopic image, while scrolling each of the objects positioned by the object positioning means, in a manner such that the longer the depth distance is, the smaller an amount of scroll becomes.

According to the above, the longer a depth distance is, the slower a scroll speed becomes, thereby farther emphasizing a sense of depth of virtual objects which are stereoscopically displayed.

Further, the display control program may further cause the computer to function as operation signal obtaining means and first object motion control means. The operation signal obtaining means obtains an operation signal corresponding to an operation performed onto an input device. The first object motion control means causes the first object to perform a motion in response to an operation signal obtained by the operation signal obtaining means. In this case, the second depth distance may be longer than the first depth distance.

According to the above, the first object which the user can operate is displayed at a closest position to the user in the depth direction, thereby allowing display on a display device of a virtual world with an emphasized sense of depth between the first object and the third object.

Further, the object positioning means may position the second object at a position at a depth distance which is shorter than the first depth distance in the depth direction in the virtual world.

According to the above, the second object is displayed at a position closer to the user in a depth direction than the first object, and displayed on at least a part of edges of a display screen of a display device, thereby emphasizing a sense of depth of the first object which is displayed as a stereoscopic image without being hidden from view by the second object.

Further, the present invention may be implemented in the form of a display control apparatus or a display control system including the above respective means, or in the form of a display control method including operations performed by the above respective means.

According to the present invention, when the first object is displayed on a display device as a stereoscopic image, the second object is displayed as a comparison target in a depth direction, thereby emphasizing a sense of depth of the first object displayed on the display device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing an example of a game apparatus 10 in an opened state;

FIG. 2 is a side view showing an example of the game apparatus 10 in the opened state;

FIG. 3A is a left side view showing an example of the game apparatus 10 in a closed state;

FIG. 3B is a front view showing an example of the game apparatus 10 in the closed state;

FIG. 3C is a right side view showing an example of the game apparatus 10 in the closed state;

FIG. 3D is a rear view showing an example of the game apparatus 10 in the closed state;

FIG. 4 is a block diagram showing an example of an internal configuration of the game apparatus 10;

FIG. 5 shows an example of the game apparatus 10 held by the user with both hands;

FIG. 6 shows an example of a display state of an image displayed on an upper LCD 22;

FIG. 7 is a conceptual diagram illustrating an example how a stereoscopic image is displayed on the upper LCD 22;

FIG. 8 is a diagram illustrating a first stereoscopic image generation method which is an example of a method for generating a stereoscopic image;

FIG. 9 is a diagram illustrating a view volume of each of virtual cameras used in the first stereoscopic image generation method;

FIG. 10 is a diagram illustrating a second stereoscopic image generation method which is an example of the method for generating a stereoscopic image;

FIG. 11 shows an example of various data stored in a main memory 32 in accordance with a display control program being executed;

FIG. 12 shows an example of object data Db in FIG. 11;

FIG. 13 is a flow chart showing an example of a display control processing operation performed by the game apparatus 10 executing the display control program;

FIG. 14 is a sub-routine showing in detail an example of an object initial positioning process performed in step 51 of FIG. 13;

FIG. 15 is a sub-routine showing in detail an example of a stereoscopic image render process performed in step 52 of FIG. 13; and

FIG. 16 is a sub-routine showing in detail an example of a scroll process performed in step 53 of FIG. 13.

### DESCRIPTION OF THE PREFERRED EMBODIMENTS

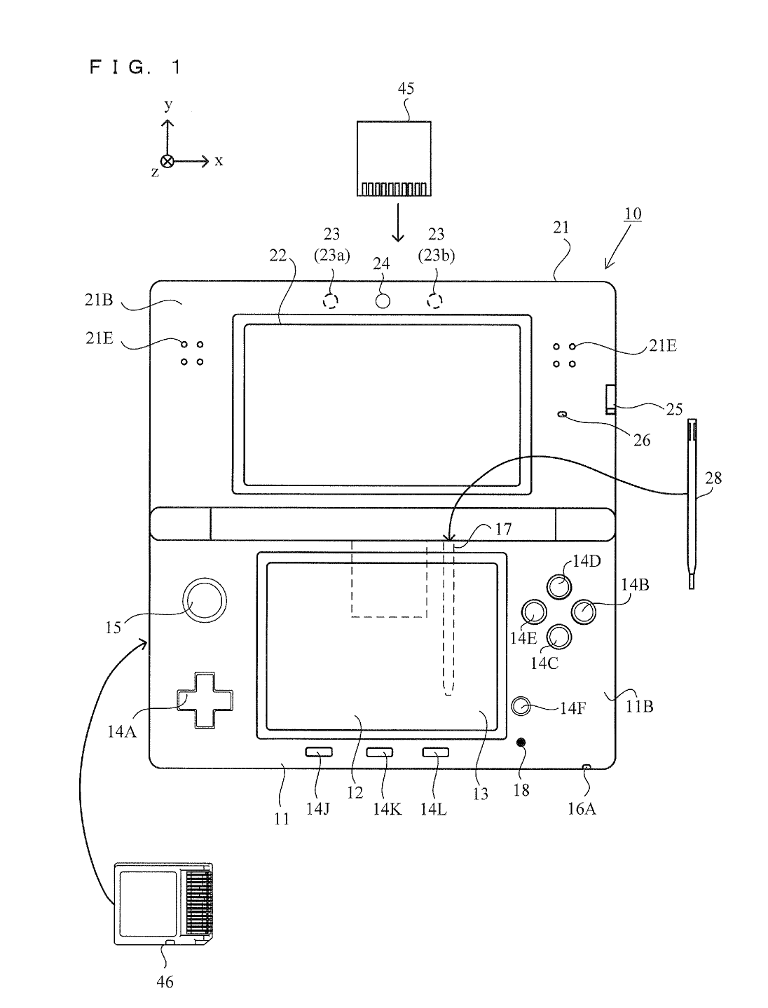

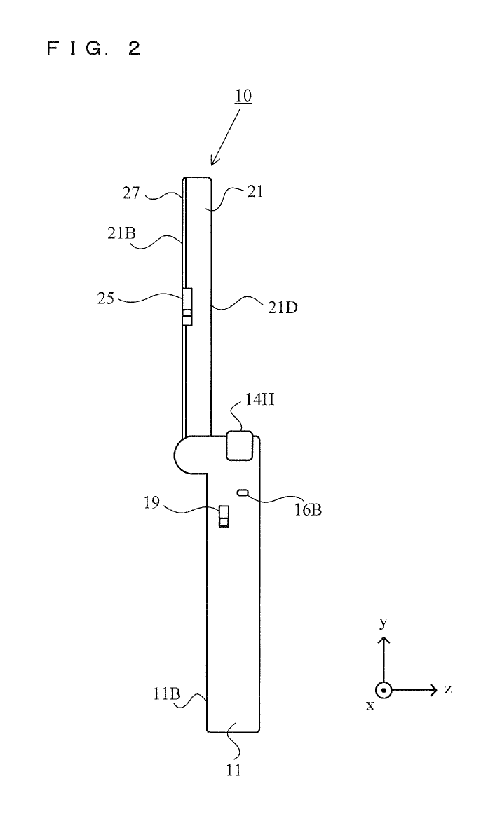

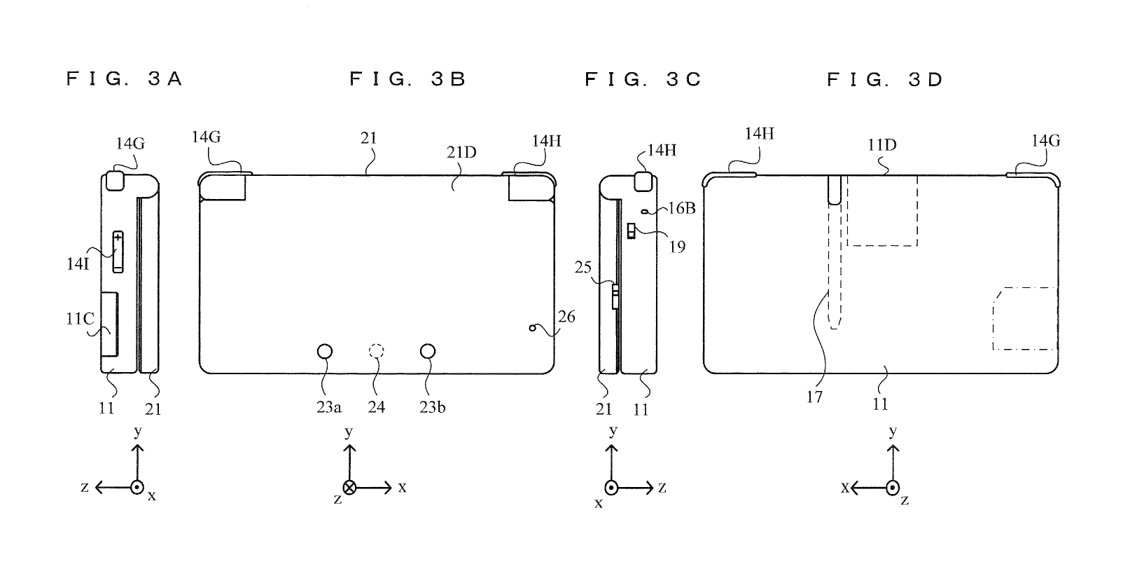

With reference to the drawings, a display control apparatus which executes a display control program according to an embodiment of the present invention will be described. The display control program of the present invention can be executed by any computer system, to be practically used. However, in the present embodiment, a hand-held game apparatus 10 is used as an example of an display control apparatus, and the display control program is executed by the game apparatus 10. FIG. 1 to FIG. 3D are each a plan view of an example of an outer appearance of the game apparatus 10. The game apparatus 10 is, for example, a hand-held game apparatus, and is configured to be foldable as shown in FIG. 1 to FIG. 3D. FIG. 1 is a front view showing an example of the game apparatus 10 in an opened state. FIG. 2 is a right side view showing an example of the game apparatus 10 in the opened state. FIG. 3A is a left side view showing an example of the game apparatus 10 in a closed state. FIG. 3B is a front view showing an example of the game apparatus 10 in the closed state. FIG. 3C is a right side view showing an example of the game apparatus 10 in the closed state. FIG. 3D is a rear view showing an example of the game apparatus 10 in the closed state. The game apparatus 10 includes an imaging section, and is able to take an image by means of the imaging section, display the taken image on a screen, and store data of the taken image. The game apparatus 10 can execute a game program which is stored in an exchangeable memory card or a game program which is received from a server or another game apparatus, and can display on the screen an image generated by computer graphics processing, such as an virtual space image seen from a virtual camera set in a virtual space, for example.

As shown in FIG. 1 to FIG. 3D, the game apparatus 10 includes a lower housing 11 and an upper housing 21. The lower housing 11 and the upper housing 21 are connected to each other so as to be openable and closable (foldable). Usually, the user uses the game apparatus 10 in the opened state. When not using the game apparatus 10, the user keeps the game apparatus 10 in the closed state.

As shown in FIG. 1 and FIG. 2, in the lower housing 11, a lower LCD (Liquid Crystal Display) 12, a touch panel 13, operation buttons 14A to 14L (FIG. 1, FIG. 3A to FIG. 3D), an analog stick 15, an LED 16A and an LED 16B, an insertion opening 17, and a microphone hole 18 are provided. Hereinafter, these components will be described in detail.

As shown in FIG. 1, the lower LCD 12 is accommodated in the lower housing 11. The number of pixels of the lower LCD 12 is, as one example, 320 dots×240 dots (the longitudinal line×the vertical line). Unlike the upper LCD 22 described below, the lower LCD 12 is a display device for displaying an image in a planar manner (not in a stereoscopically visible manner). Although an LCD is used as a display device in the present embodiment, any other display device such as a display device using an EL (Electro Luminescence), or the like may be used. In addition, a display device having any resolution may be used as the lower LCD 12.

As shown in FIG. 1, the game apparatus 10 includes the touch panel 13 as an input device. The touch panel 13 is mounted on the screen of the lower LCD 12 in such a manner as to cover the screen. In the present embodiment, the touch panel 13 may be, but is not limited to, a resistive film type touch panel. A touch panel of any press type such as electrostatic capacitance type may be used. In the present embodiment, the touch panel 13 has the same resolution (detection accuracy) as that of the lower LCD 12. However, the resolution of the touch panel 13 and the resolution of the lower LCD 12 may not necessarily be the same. Further, the insertion opening 17 (indicated by dashed line in FIG. 1 and FIG. 3D) is provided on the upper side surface of the lower housing 11. The insertion opening 17 is used for accommodating a touch pen 28 which is used for performing an operation on the touch panel 13. Although an input on the touch panel 13 is usually made by using the touch pen 28, a finger of a user may be used for making an input on the touch panel 13, in addition to the touch pen 28.

The operation buttons 14A to 14L are each an input device for making a predetermined input. As shown in FIG. 1, among operation buttons 14A to 14L, a cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11. The cross button 14A is cross-shaped, and includes buttons for indicating an upward, a downward, a leftward, or a rightward direction. The button 14A to 14E, the selection button 14J, the HOME button 14K, and the start button 14L are assigned functions, respectively, in accordance with a program executed by the game apparatus 10, as necessary. For example, the cross button 14A is used for selection operation and the like, and the operation buttons 14B to 14E are used for, for example, determination operation and cancellation operation. The power button 14F is used for powering the game apparatus 10 on/off.

The analog stick 15 is a device for indicating a direction. The analog stick 15 has a top, corresponding to a key, which slides parallel to the inner side surface of the lower housing 11. The analog stick 15 acts in accordance with a program executed by the game apparatus 10. For example, when a game in which a predetermined object appears in a three-dimensional virtual space is executed by the game apparatus 10, the analog stick 15 acts as an input device for moving the predetermined object in the three-dimensional virtual space. In this case, the predetermined object is moved in a direction in which the top corresponding to the key of the analog stick 15 slides. As the analog stick 15, a component which enables an analog input by being tilted by a predetermined amount, in any direction, such as the upward, the downward, the rightward, the leftward, or the diagonal direction, may be used.

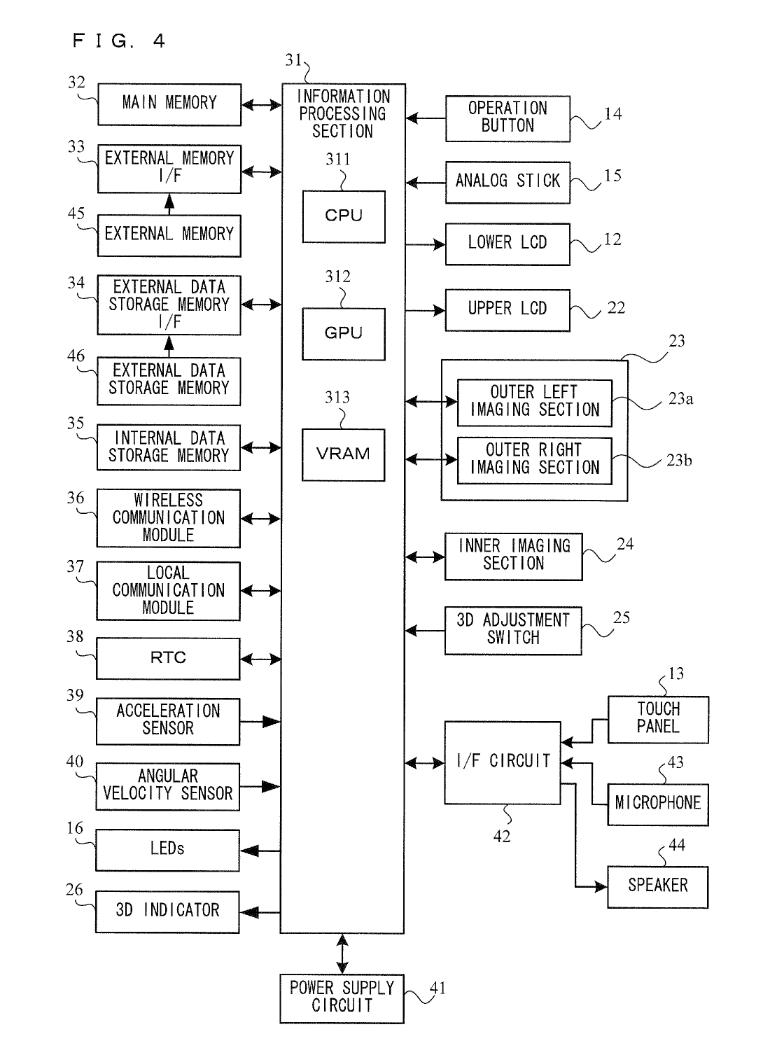

Further, the microphone hole 18 is provided on the inner side surface of the lower housing 11. Under the microphone hole 18, a microphone 43 (see FIG. 4) is provided as a sound input device described below, and the microphone 43 detects a sound from the outside of the game apparatus 10.

As shown in FIG. 3B and FIG. 3D, an L button 14G and an R button 14H are provided on the upper side surface of the lower housing 11. For example, the L button 14G and the R button 14H act as shutter buttons (photographing instruction buttons) of the imaging section. Further, as shown in FIG. 3A, a sound volume button 14I is provided on the left side surface of the lower housing 11. The sound volume button 14I is used for adjusting a sound volume of a speaker of the game apparatus 10.

As shown in FIG. 3A, a cover section 11C is provided on the left side surface of the lower housing 11 so as to be openable and closable. Inside the cover section 11C, a connector (not shown) is provided for electrically connecting the game apparatus 10 to an external data storage memory 46. The external data storage memory 46 is detachably connected to the connector. The external data storage memory 46 is used for, for example, recording (storing) data of an image taken by the game apparatus 10.

Further, as shown in FIG. 3D, an insertion opening 11D through which an external memory 45 having a game program stored therein is inserted is provided on the upper side surface of the lower housing 11. A connector (not shown) for electrically connecting the game apparatus 10 to the external memory 45 in a detachable manner is provided inside the insertion opening 11D. A predetermined game program is executed by connecting the external memory 45 to the game apparatus 10.

As shown in FIG. 1, a first LED 16A for notifying a user of an ON/OFF state of a power supply of the game apparatus 10 is provided on the lower side surface of the lower housing 11. As shown in FIG. 3C, a second LED 16B for notifying a user of an establishment state of a wireless communication of the game apparatus 10 is provided on the right side surface of the lower housing 11. The game apparatus 10 can make wireless communication with other devices, and the second LED 16B is lit up when the wireless communication is established with another device. The game apparatus 10 has a function of connecting to a wireless LAN in a method based on, for example, IEEE802.11.b/g standard. A wireless switch 19 for enabling/disabling the function of the wireless communication is provided on the right side surface of the lower housing 11 (see FIG. 3C).

A rechargeable battery (not shown) acting as a power supply for the game apparatus 10 is accommodated in the lower housing 11, and the battery can be charged through a terminal provided on a side surface (for example, the upper side surface) of the lower housing 11.

In the upper housing 21, an upper LCD (Liquid Crystal Display) 22, two outer imaging sections 23 (an outer left imaging section 23a and an outer right imaging section 23b), an inner imaging section 24, a 3D adjustment switch 25, and a 3D indicator 26 are provided. Hereinafter, theses components will be described in detail.

As shown in FIG. 1, the upper LCD 22 is accommodated in the upper housing 21. The number of pixels of the upper LCD 22 is, as one example, 800 dots×240 dots (the horizontal line×the vertical line). Although, in the present embodiment, the upper LCD 22 is an LCD, a display device using an EL (Electro Luminescence), or the like may be used. In addition, a display device having any resolution may be used as the upper LCD 22.

The upper LCD 22 is a display device capable of displaying a stereoscopically visible image. The upper LCD 22 can display an image for a left eye and an image for a right eye by using substantially the same display area. Specifically, the upper LCD 22 may be a display device using a method in which the image for a left eye and the image for a right eye are alternately displayed in the horizontal direction in predetermined units (for example, every other line). As an example, when the upper LCD 22 is configured to have a number of pixels of 800 dots in the horizontal direction×240 dots in the vertical direction, a stereoscopic view is realized by assigning to the image 400 pixels in the horizontal direction for a left eye and 400 pixels in the horizontal direction for a right eye such that the pixels of the image for a left eye and the pixels of the image for a right eye are alternately arranged. It should be noted that the upper LCD 22 may be a display device using a method in which the image for a left eye and the image for a right eye are alternately displayed. Further, the upper LCD 22 is a display device capable of displaying an image which is stereoscopically visible with naked eyes. In this case, as the upper LCD 22, a lenticular lens type display device or a parallax barrier type display device is used which enables the image for a left eye and the image for a right eye, which are alternately displayed in the horizontal direction, to be separately viewed by the left eye and the right eye. In the present embodiment, the upper LCD 22 of a parallax barrier type is used. The upper LCD 22 displays, by using the image for a right eye and the image for a left eye, an image (a stereoscopic image) which is stereoscopically visible with naked eyes. That is, the upper LCD 22 allows a user to view the image for a left eye with her/his left eye, and the image for a right eye with her/his right eye by utilizing a parallax barrier, so that a stereoscopic image (a stereoscopically visible image) exerting a stereoscopic effect for a user can be displayed. Further, the upper LCD 22 may disable the parallax barrier. When the parallax barrier is disabled, an image can be displayed in a planar manner (it is possible to display a planar image which is different from a stereoscopic image as described above. Specifically, the planner manner is a display mode in which the same displayed image is viewed with a left eye and a right eye). Thus, the upper LCD 22 is a display device capable of switching between a stereoscopic display mode for displaying a stereoscopically visible image and a planar display mode for displaying an image in a planar manner (for displaying a planar visible image). The switching of the display mode is performed by the 3D adjustment switch 25 described below.

Two imaging sections (outer left imaging section 23a and outer right imaging section 23b) provided on the outer side surface (the back surface reverse of the main surface on which the upper LCD 22 is provided) 21D of the upper housing 21 are collectively referred to as the outer imaging section 23. The imaging directions of the outer left imaging section 23a and the outer right imaging section 23b are each the same as the outward normal direction of the outer side surface 21D. The outer left imaging section 23a and the outer right imaging section 23b can be used as a stereo camera depending on a program executed by the game apparatus 10. Each of the outer left imaging section 23a and the outer right imaging section 23b includes an imaging device, such as a CCD image sensor or a CMOS image sensor, having a common predetermined resolution, and a lens. The lens may have a zooming mechanism.

The inner imaging section 24 is positioned on the inner side surface (main surface) 21B of the upper housing 21, and acts as an imaging section which has an imaging direction which is the same direction as the inward normal direction of the inner side surface. The inner imaging section 24 includes an imaging device, such as a CCD image sensor and a CMOS image sensor, having a predetermined resolution, and a lens. The lens may have a zooming mechanism.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic image) which is displayed on the upper LCD 22. The 3D adjustment switch 25 has a slider which is slidable to any position in a predetermined direction (for example, along the longitudinal direction of the right side surface), and a display mode of the upper LCD 22 is determined in accordance with the position of the slider. A manner in which the stereoscopic image is visible is adjusted in accordance with the position of the slider. Specifically, an amount of displacement in the horizontal direction between a position of an image for a right eye and a position of an image for a left eye is adjusted in accordance with the position of the slider.

The 3D indicator 26 indicates whether or not the upper LCD 22 is in the stereoscopic display mode. For example, the 3D indicator 26 is implemented as a LED, and is lit up when the stereoscopic display mode of the upper LCD 22 is enabled. The 3D indicator 26 may be lit up only when the program processing for displaying a stereoscopic image is performed in a state where the upper LCD 22 is in the stereoscopic display mode.

Further, a speaker hole 21E is provided on the inner side surface of the upper housing 21. A sound is outputted through the speaker hole 21E from a speaker 44 described below.

Next, with reference to FIG. 4, an internal configuration of the game apparatus 10 will be described. FIG. 4 is a block diagram showing an example of an internal configuration of the game apparatus 10.

In FIG. 4, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, an angular velocity sensor 40, a power supply circuit 41, an interface circuit (I/F circuit) 42, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. In the present embodiment, a predetermined program is stored in a memory (for example, the external memory 45 connected to the external memory I/F 33 or the internal data storage memory 35) inside the game apparatus 10. The CPU 311 of the information processing section 31 executes image processing and game processing described below by executing the predetermined program. The program executed by the CPU 311 of the information processing section 31 may be obtained from another device through communication with the other device. The information processing section 31 further includes a VRAM (Video RAM) 313. The GPU 312 of the information processing section 31 generates an image in accordance with an instruction from the CPU 311 of the information processing section 31, and renders the image in the VRAM 313. The GPU 312 of the information processing section 31 outputs the image rendered in the VRAM 313, to the upper LCD 22 and/or the lower LCD 12, and the image is displayed on the upper LCD 22 and/or the lower LCD 12.

To the information processing section 31, the main memory 32, the external memory I/F 33, the external data storage memory I/F 34, and the internal data storage memory 35 are connected. The external memory I/F 33 is an interface for detachably connecting to the external memory 45. The external data storage memory I/F 34 is an interface for detachably connecting to the external data storage memory 46.

The main memory 32 is volatile storage means used as a work area and a buffer area for (the CPU 311 of) the information processing section 31. That is, the main memory 32 temporarily stores various types of data used for the image processing and the game processing, and temporarily stores a program obtained from the outside (the external memory 45, another device, or the like), for example. In the present embodiment, for example, a PSRAM (Pseudo-SRAM) is used as the main memory 32.

The external memory 45 is nonvolatile storage means for storing a program executed by the information processing section 31. The external memory 45 is implemented as, for example, a read-only semiconductor memory. When the external memory 45 is connected to the external memory I/F 33, the information processing section 31 can load a program stored in the external memory 45. A predetermined process is performed by the program loaded by the information processing section 31 being executed. The external data storage memory 46 is implemented as a non-volatile readable and writable memory (for example, a NAND flash memory), and is used for storing predetermined data. For example, images taken by the outer imaging section 23 and/or images taken by another device are stored in the external data storage memory 46. When the external data storage memory 46 is connected to the external data storage memory I/F 34, the information processing section 31 loads an image stored in the external data storage memory 46, and the image can be displayed on the upper LCD 22 and/or the lower LCD 12.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method based on, for example, IEEE 802.11.b/g standard. The local communication module 37 has a function of performing wireless communication with the same type of game apparatus in a predetermined communication method (for example, infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. The acceleration sensor 39 detects magnitudes of accelerations (linear accelerations) in the directions of the straight lines along the three axial directions (xyz axial directions in the present embodiment), respectively. The acceleration sensor 39 is provided inside the lower housing 11, for example. In the acceleration sensor 39, as shown in FIG. 1, the long side direction of the lower housing 11 is defined as x axial direction, the short side direction of the lower housing 11 is defined as y axial direction, and the direction orthogonal to the inner side surface (main surface) of the lower housing 11 is defined as z axial direction, thereby detecting magnitudes of the linear accelerations generated in the respective axial directions of the game apparatus 10, respectively. The acceleration sensor 39 is, for example, an electrostatic capacitance type acceleration sensor. However, another type of acceleration sensor may be used. The acceleration sensor 39 may be an acceleration sensor for detecting a magnitude of an acceleration for one axial direction or two-axial directions. The information processing section 31 receives data (acceleration data) representing accelerations detected by the acceleration sensor 39, and calculates an orientation and a motion of the game apparatus 10.

The angular velocity sensor 40 is connected to the information processing section 31. The angular velocity sensor 40 detects angular velocities generated around the three axes (xyz axes in the present embodiment), respectively, of the game apparatus 10, and outputs data representing the detected angular velocities (angular velocity data) to the information processing section 31. The angular velocity sensor 40 is provided in the lower housing 11, for example. The information processing section 31 receives the angular velocity data outputted by the angular velocity sensor 40 and calculates an orientation and a motion of the game apparatus 10.

The RTC 38 and the power supply circuit 41 are connected to the information processing section 31. The RTC 38 counts time, and outputs the time to the information processing section 31. The information processing section 31 calculates a current time (date) based on the time counted by the RTC 38. The power supply circuit 41 controls power from the power supply (the rechargeable battery accommodated in the lower housing 11 as described above) of the game apparatus 10, and supplies power to each component of the game apparatus 10.

The I/F circuit 42 is connected to the information processing section 31. The microphone 43, the speaker 44, and the touch panel 13 are connected to the I/F circuit 42. Specifically, the speaker 44 is connected to the I/F circuit 42 through an amplifier which is not shown. The microphone 43 detects a voice from a user, and outputs a sound signal to the I/F circuit 42. The amplifier amplifies a sound signal outputted from the I/F circuit 42, and a sound is outputted from the speaker 44. The I/F circuit 42 includes a sound control circuit for controlling the microphone 43 and the speaker 44 (amplifier), and a touch panel control circuit for controlling the touch panel 13. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The touch position data represents coordinates of a position, on an input surface of the touch panel 13, on which an input is made (touch position). The touch panel control circuit reads a signal outputted from the touch panel 13, and generates the touch position data every predetermined time. The information processing section 31 obtains the touch position data, to recognize a touch position on which an input is made on the touch panel 13.

The operation button 14 includes the operation buttons 14A to 14L described above, and is connected to the information processing section 31. Operation data representing an input state of each of the operation buttons 14A to 14I is outputted from the operation button 14 to the information processing section 31, and the input state indicates whether or not each of the operation buttons 14A to 14I has been pressed. The information processing section 31 obtains the operation data from the operation button 14 to perform a process in accordance with the input on the operation button 14.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, for example, the information processing section 31 causes the lower LCD 12 to display an image for input operation, and causes the upper LCD 22 to display an image obtained from one of the outer imaging section 23 or the inner imaging section 24. That is, the information processing section 31 causes the upper LCD 22 to display a stereoscopic image (stereoscopically visible image) using an image for a right eye and an image for a left eye which are taken by the outer imaging section 23, causes the upper LCD 22 to display a planar image taken by the inner imaging section 24, and causes the upper LCD 22 to display a planar image using one of an image for a right eye and an image for a left eye which are taken by the outer imaging section 23, for example.

Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye, (taken by the outer imaging section 23), which are stored in the VRAM 313 of the information processing section 31 are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically visible image is displayed on the screen of the upper LCD 22.

The outer imaging section 23 and the inner imaging section 24 are connected to the information processing section 31. The outer imaging section 23 and the inner imaging section 24 each take an image in accordance with an instruction from the information processing section 31, and output data of the taken image to the information processing section 31. In the present embodiment, the information processing section 31 issues an instruction for taking an image to one of the outer imaging section 23 and the inner imaging section 24, and the imaging section which receives the instruction for taking an image takes an image and transmits data of the taken image to the information processing section 31. Specifically, a user selects the imaging section to be used through an operation using the touch panel 13 and the operation buttons 14. When the information processing section 31 (the CPU 311) detects that the imaging section is selected, the information processing section 31 instructs one of the outer imaging section 23 and the inner imaging section 24 to take an image.

The 3D adjustment switch 25 is connected to the information processing section 31. The 3D adjustment switch 25 transmits, to the information processing section 31, an electrical signal in accordance with the position of the slider.

The 3D indicator 26 is connected to the information processing section 31. The information processing section 31 controls whether or not the 3D indicator 26 is to be lit up. For example, the information processing section 31 lights up the 3D indicator 26 when the upper LCD 22 is in the stereoscopic display mode.

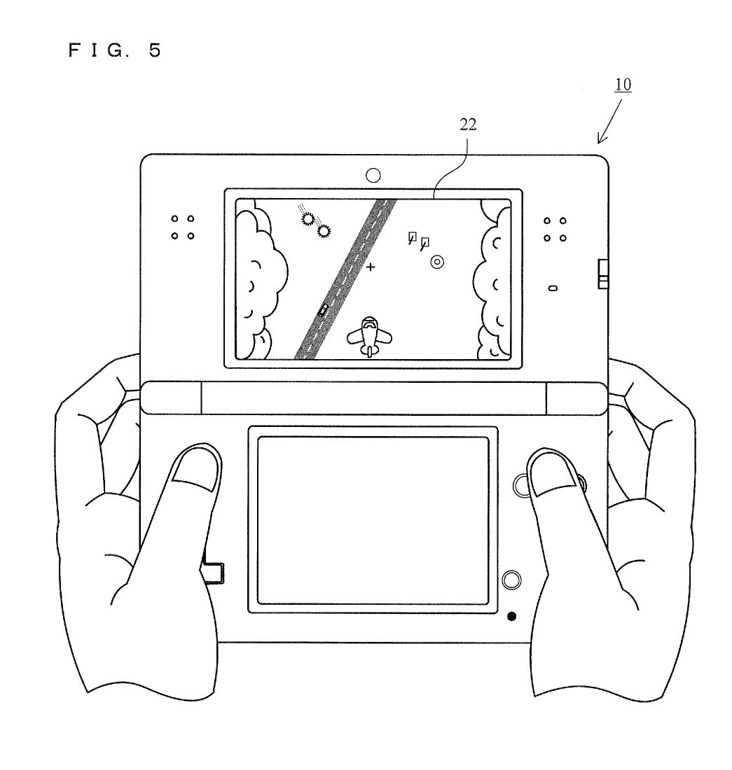

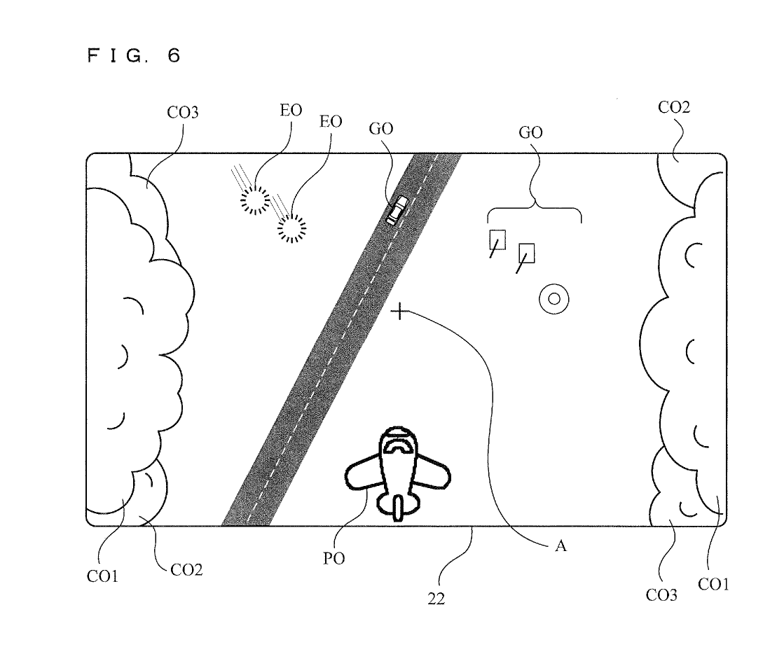

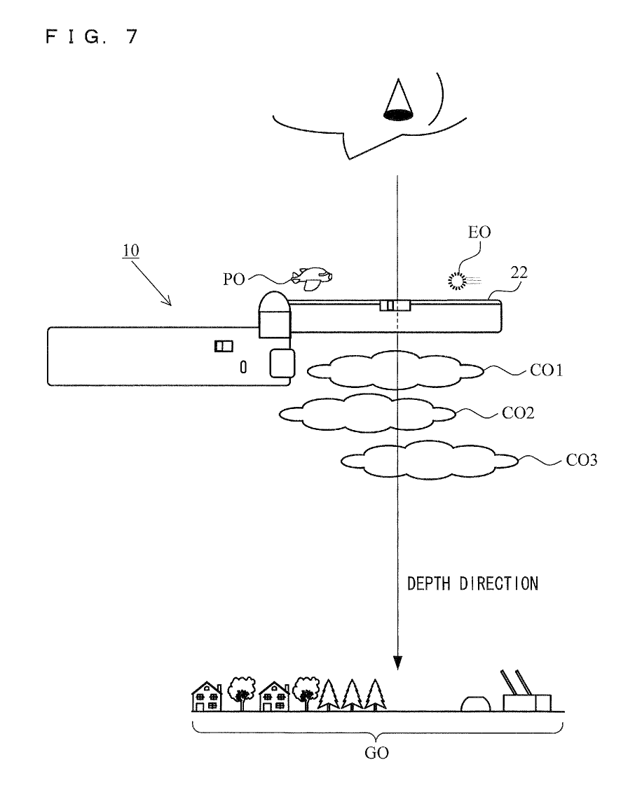

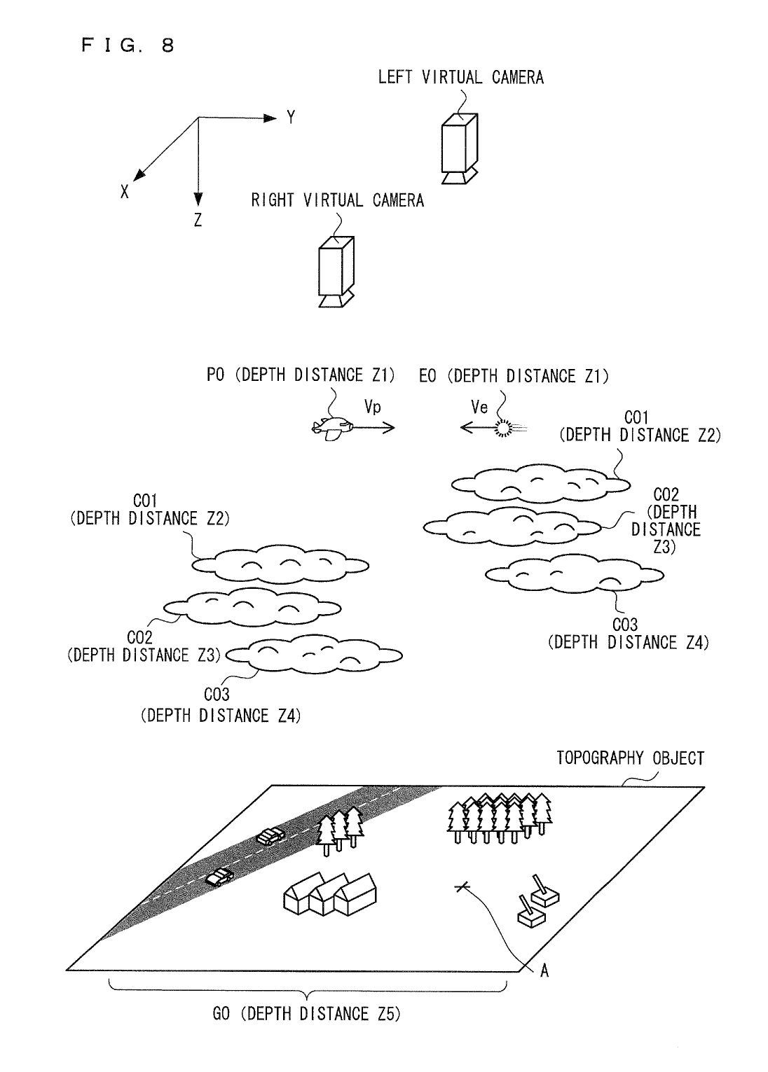

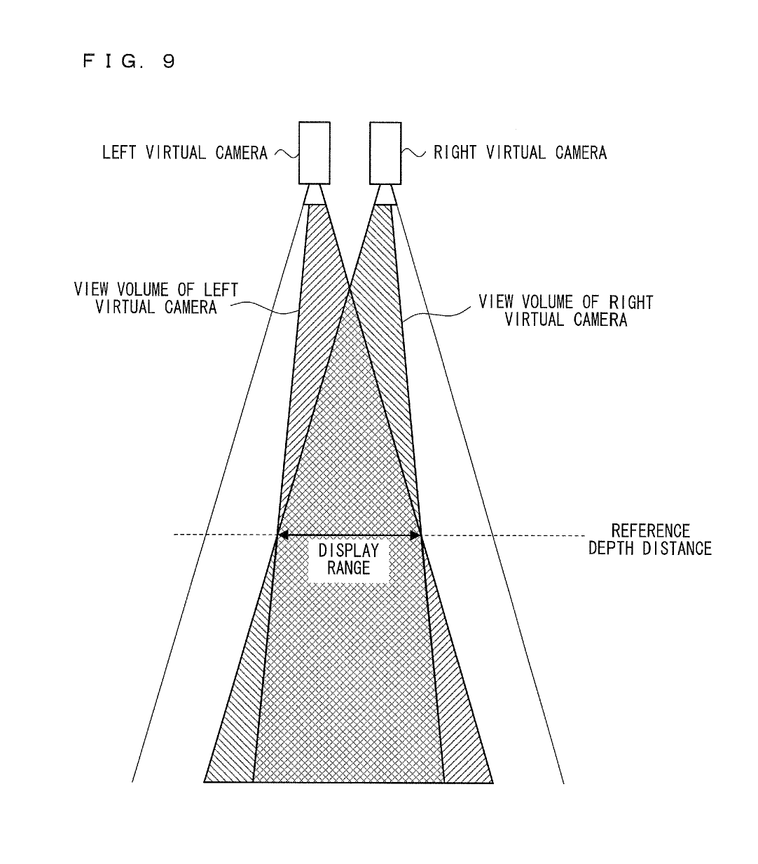

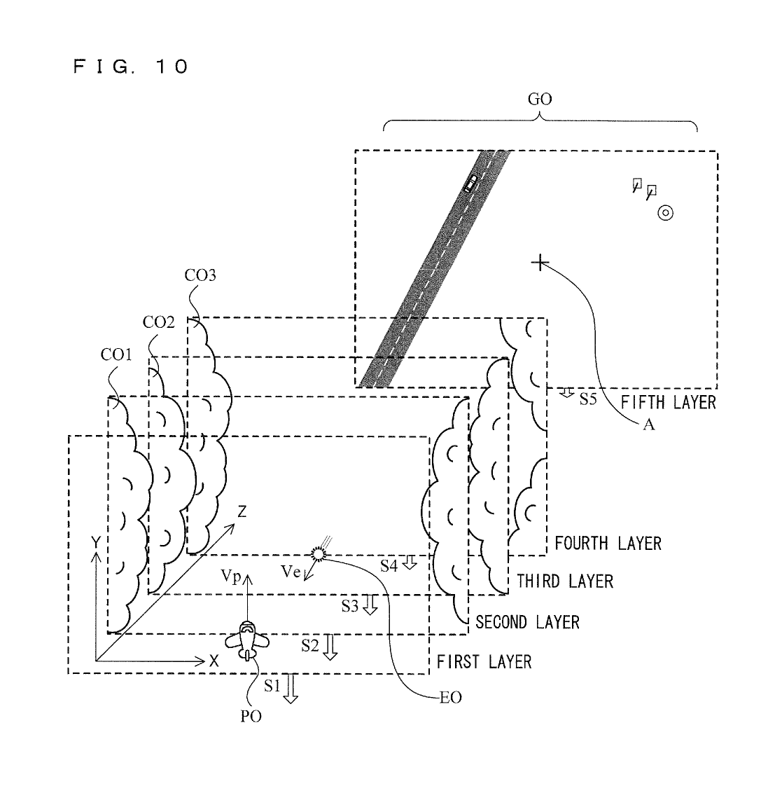

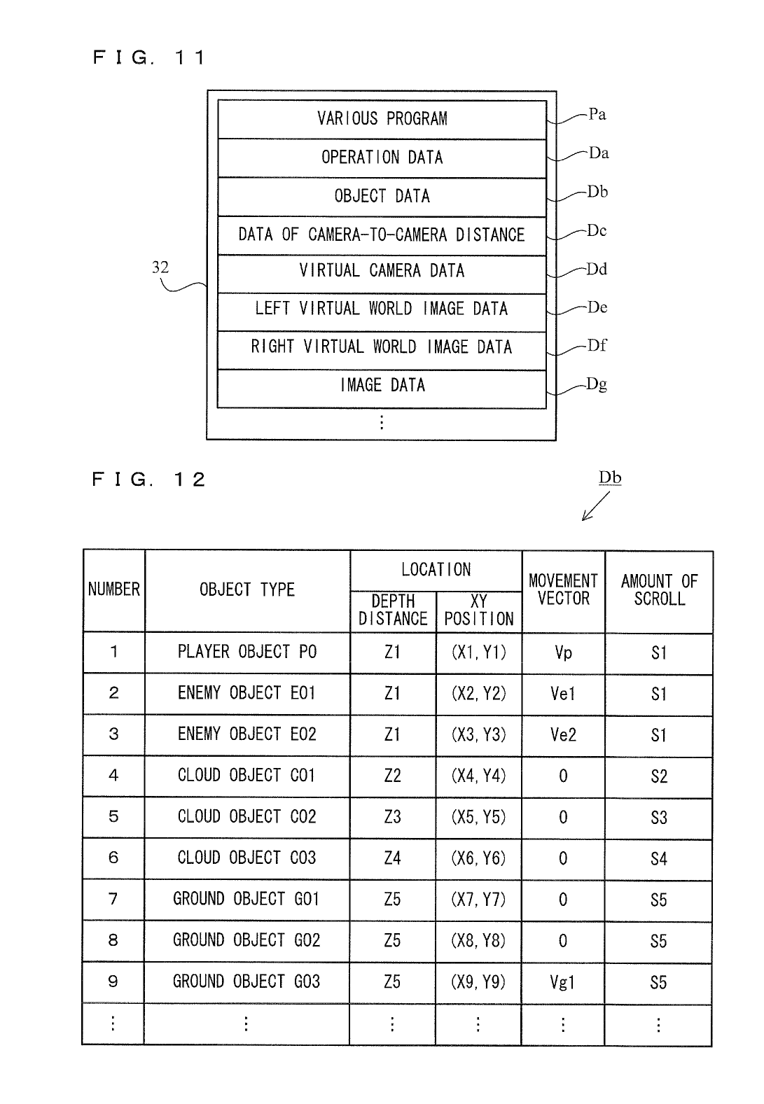

Next, with reference to FIG. 5 to FIG. 10, description is given of an example of a state in which the game apparatus 10 is used and of display contents to be displayed on the game apparatus 10. FIG. 5 shows an example of the game apparatus 10 held by the user with both hands. FIG. 6 shows an example of a display state of an image displayed on the upper LCD 22. FIG. 7 is a conceptual diagram illustrating an example how a stereoscopic image is displayed on the upper LCD 22. FIG. 8 is a diagram illustrating a first stereoscopic image generation method which is an example of a method for generating a stereoscopic image. FIG. 9 is a diagram illustrating a view volume of each of virtual cameras used in the first stereoscopic image generation method. FIG. 10 is a diagram illustrating a second stereoscopic image generation method which is an example of a method for generating a stereoscopic image.

As shown in FIG. 5, the user holds the side surfaces and the outer side surface (the surface reverse of the inner side surface) of the lower housing 11 with his/her palms, middle fingers, ring fingers, and little fingers of both hands such that the lower LCD 12 and the upper LCD 22 face the user. This allows the user to perform operations onto the operation buttons 14A to 14E and the analog stick 15 by using his/her thumbs, and operations onto the L button 14G and the R button 14H with his/her index fingers, while holding the lower housing 11. Accordingly, the user can move a player object which appears in a virtual world and cause the player object to perform a predetermined motion (attack motion, for example) by operating the operation buttons 14A to 14E and the analog stick 15.

As shown in FIG. 6, for example, a virtual world image which is a bird's-eye view of a virtual world including a player object PO is stereoscopically displayed on the upper LCD 22. The player object PO is a flying object (for example, an aircraft such as a fighter plane) which flies in the air in the virtual world, and is displayed on the upper LCD 22 in a manner such that the top side of the player object PO is displayed with its front side facing in the upward direction of the upper LCD 22. The player object PO can move within a display range of the upper LCD 22 in accordance with an operation performed by the user; however, because the virtual world in which the player object PO flies is scroll-displayed in a constant direction (from the upward to the downward direction of the upper LCD 22, for example), the player object PO also flies in the constant direction in the virtual world as a game progresses.

On a ground set on the virtual world, a plurality of ground objects GO are positioned. Here, the ground objects GO each may be an object which is fixedly positioned on the ground of the virtual world, an object which moves on the ground, or an object which attacks the player object PO in the air based on a predetermined algorithm. In accordance with a predetermined attack operation (of pressing an operation button (A button) 14B, for example), the player object PO discharges a ground attack bomb toward a position on the ground indicated by a shooting aim A. Accordingly, by performing the predetermined attack operation, the user can attack each ground object GO which the shooting aim A overlaps. The shooting aim A, being in a fixed relationship with the player object PO, moves along the ground in the virtual world in accordance with the movement of the player object PO.

In the air of the virtual world, an enemy object BO occasionally appears. In order to interfere with the flight of the player object PO, the enemy object EO appears in the air of the virtual world and attacks the player object PO based on a predetermined algorithm. Meanwhile, in accordance with a predetermined attack operation (of pressing an operation button (B button) 14C, for example), the player object PO discharges an air attack bomb from the front side of the player object PO toward the direction (that is, the upward direction of the upper LCD 22) in which the player object is facing. Accordingly, by performing the predetermined attack operation, the user can attack the enemy object EO which is flying in front of the player object PO.

Further, a plurality of cloud objects CO are positioned in the air of the virtual world. The plurality of cloud objects CO are displayed on the upper LCD 22 at both edges thereof (a left edge and a right edge of the upper LCD 22 when the up-down direction is a scroll direction) opposite to each other along the scroll direction in the virtual world. By positioning the plurality of cloud objects CO in the virtual world so as to extend along the scroll direction at respective positions corresponding to the both edges, the plurality of cloud objects CO are constantly (or any time, always, continuously, sequentially, incessantly, etc.) displayed at the both edges when an image of the virtual world is scroll-displayed in the scroll direction. In addition, the plurality of cloud objects CO are displayed only at the both edges. In an example shown in FIG. 6, three cloud objects CO1 to CO3 overlap one another and displayed respectively at the left edge and the right edge of the upper LCD 22, the three cloud objects CO1 to CO3 being positioned at different altitudes from one another in the air of the virtual world.

Each ground object GO positioned on the ground of the virtual world is positioned at a position other than the both edges opposite to each other along the scroll direction in the virtual world. Arrangement of each ground object GO at the position other than the both edges allows to prevent the cloud objects CO positioned in the air from hiding the ground objects GO from view.

Next, altitudes (distance in the depth direction) at which virtual objects are respectively positioned in the virtual world will be described. As shown in FIG. 7, when a stereoscopic image of the virtual world is displayed on the upper LCD 22, the virtual objects are positioned at respective positions (altitudes different from one another in the virtual world) different from one another with respect to the depth direction of the stereoscopic image. For example, the player object PO and the enemy object EO are positioned at the highest altitude in the virtual world (a position closest to the user's viewpoint and a position at the shortest depth distance; the depth distance indicating a depth is hereinafter referred to as a depth distance Z1), and fly in the virtual world with maintaining the altitude. Each ground object GO is positioned at the lowest altitude on the ground in the virtual world (a position farthest from the user's viewpoint and a position at the longest depth distance; the depth distance indicating a depth is hereinafter referred to as a depth distance Z5), and moves on the ground in the virtual world with maintaining the ground altitude.

The cloud objects CO1 to CO3 are positioned at positions at an altitude between a position where the player object PO is positioned and a position where the ground objects GO are positioned. That is, the cloud objects CO1 to CO3 are positioned, from the user's viewpoint, at a position farther than the player object PO and closer than the ground objects GO. Specifically, the cloud objects CO are positioned at a depth distance Z2. The cloud objects CO2 are positioned at a depth distance Z3 which is longer than the depth distance Z2. The cloud objects CO3 are positioned at a depth distance Z4 which is longer than the depth distance Z3. In this case, the depth distance Z1<the depth distance Z2 <the depth distance Z3<the depth distance Z4<the depth distance Z5.

Accordingly, positioning of the cloud objects CO1 to CO3 at the position between the player object PO and the ground objects GO in the depth direction of the stereoscopically displayed virtual world can emphasize a sense of depth between the player object PO and the ground objects GO. In addition, the cloud objects CO1 to CO3 are always displayed respectively at the both edges of the upper LCD 22 opposite to each other along the scroll direction, thereby always keeping sight of the player object PO and the ground objects GO without hiding the player object PO and the ground objects GO from view.

Here, the player object PO and the ground objects GO are indispensable objects (objects which affect a game play and a game progress), while the cloud objects CO1 to CO3 are objects which are not indispensable in a game and are used only for emphasizing a sense of depth between the player object PO and the ground objects GO. The player object PO and each ground object GO attack each other and hit determinations are made with respect to each of the player object PO and the ground objects GO accordingly, thereby affecting the game in a way, for example, that a score is added or the game is ended in accordance with the game play or the game progress. Meanwhile, hit determinations are not made with respect to the cloud objects CO1 to CO3, and thus the cloud objects CO1 to CO3 affect neither the game play nor the game progress. In other words, if the virtual world is displayed as a two-dimensional image, the cloud objects CO1 to CO3 are not necessary as long as there are the player object PO and the ground objects GO.

In other words, the present invention is appropriate for reforming a conventional game in which two objects in two respective depth areas are displayed as a two-dimensional image into a game in which the two objects can be displayed as a stereoscopic image as well as the two-dimensional image. In addition, the present invention can display the stereoscopic image with an emphasized sense of depth between the two objects.

Next, the first stereoscopic image generation method which is an example of a method for generating a stereoscopic image representing the above described virtual world will be described. As shown in FIG. 8, virtual objects are respectively positioned in a virtual space defined by a predetermined coordinate system (world coordinate system, for example). In the example shown in FIG. 8, in order to provide a specific description, two virtual cameras (a left virtual camera and a right virtual camera) are positioned in the virtual space, and a camera coordinate system is indicated in which a view line direction of the virtual cameras is set as a Z-axis positive direction; a rightward direction of the virtual cameras facing in the Z-axis positive direction is set as an X-axis positive direction; and an upward direction of the virtual cameras is set as a Y-axis positive direction. The left virtual camera and the right virtual camera are arranged in the virtual space in a manner such that a camera-to-camera distance which is calculated based on a position of the slider of the 3D adjustment switch 25 is provided therebetween, and arranged in accordance with the directions of the camera coordinate system, respectively. Generally, a world coordinate system is defined in a virtual space; however, to explain a relationship between the virtual objects and the virtual cameras arranged in the virtual space, positions in the virtual space will be described by using the camera coordinate system.

In the virtual space, the ground objects GO are positioned on a topography object set on an XY plane at the depth distance Z5 from each of the left virtual camera and the right virtual camera. The player object PO and the enemy object EO are positioned above the topography object in the virtual space at an altitude at the depth distance Z1 from each of the left virtual camera and the right virtual camera. In accordance with a moving speed and a moving direction (movement vector Vp) calculated based on an operation performed by the user, the player object PO moves in the virtual space within its movement range which is the view volumes of the left virtual camera and the right virtual camera with the front side (flight direction) thereof facing in the Y-axis positive direction. Based on a predetermined algorithm, the enemy object EO appears in the virtual space and a movement vector Ve is set thereto, and moves in the virtual space based on the movement vector Ve.

In the above description, the objects move on the respectively set planes; however, a space having a predetermined distance in the depth direction may be set, and each object may move in the space. In this case, each object may be set so as to have a depth different from that of each of the other objects.

The left virtual camera and the right virtual camera each has a view volume defined by the display range of the upper LCD 22. For example, as shown in FIG. 9, when generating a stereoscopic image of the virtual space by using the virtual cameras (the left virtual camera and the right virtual camera), a range to be displayed from each of the images of the virtual space obtained from the two virtual cameras on the upper LCD 22 needs to be adjusted. Specifically, when a stereoscopic image is displayed, the display range of the virtual space obtained from the left virtual camera and the display range of the virtual space obtained from the right virtual camera are adjusted so as to coincide with each other in the virtual space at a reference depth distance which coincides with a position of the display screen of the upper LCD 22 (that is, a front surface of the upper LCD 22). In the description of the present application, the view volume of the left virtual camera and the view volume of the right virtual camera are set so as to coincide with the respective display ranges adjusted as described above. That is, in the description of the present application, all of the virtual objects contained in the view volume of the left virtual camera and the virtual objects contained in the view volume of the right virtual camera are displayed on the upper LCD 22.

In the virtual space, the cloud objects CO1 are positioned in the air above the topography object and below the player object PO at an altitude at the depth distance Z2 from each of the left virtual camera and the right virtual camera. The cloud objects CO1 are positioned along a Y-axis direction which is a direction in which the virtual space is scroll-displayed, at each of positions corresponding to the left edge and the right edge in each of the view volumes of the left virtual camera and the right virtual camera. In the virtual space, the cloud objects CO2 are positioned in the air above the topography object and below the player object PO and the cloud objects CO1 at an altitude at the depth distance Z3 from each of the left virtual camera and the right virtual camera. The cloud objects CO2 are also positioned along the Y-axis direction which is the direction in which the virtual space is scroll-displayed, at each of the positions corresponding to the left edge and the right edge in each of the view volumes of the left virtual camera and the right virtual camera. In the virtual space, the cloud objects CO3 are positioned in the air of the topography object and below the player object PO, the cloud objects CO1, and the cloud objects CO2 at an altitude at the depth distance Z4 from each of the left virtual camera and the right virtual camera. The cloud objects CO3 are positioned along the Y-axis direction which is the direction in which the virtual space is scroll-displayed, at each of the positions corresponding to the left edge and the right edge in each of the view volumes of the left virtual camera and the right virtual camera.

By using the virtual space set accordingly, the virtual space seen from the left virtual camera is generated as a virtual world image for a left eye (left virtual world image) while the virtual space seen from the right virtual camera is generated as a virtual world image for a right eye (right virtual world image). By displaying the generated left virtual world image and the right virtual world image on the upper LCD 22, a stereoscopic image of the virtual world as described with reference to FIGS. 5 to 7 is displayed on the upper LCD 22. By periodically scrolling the two virtual cameras and/or the virtual objects of the virtual space in the Y-axis direction, the virtual world is displayed while being sequentially scrolled in a downward direction of the upper LCD 22. As will be apparent later, an amount of movement by scrolling (amount of scroll) in the Y-axis direction is set to a value that changes depending on the depth distance Z at which the virtual object is positioned. That is, because the amount of scroll changes in accordance with a location of each virtual object, the scroll display may be preferably realized by periodically scrolling the virtual objects of the virtual space in accordance with the amounts of scroll respectively set in the Y-axis negative direction.

Next, as another example of the method for generating a stereoscopic image representing the above described virtual world, a second stereoscopic image generation method will be described. As shown in FIG. 10, the virtual objects are rendered on respective layers set on XY planes set at stepwise depth distances in a Z-axis direction. For example, the layers shown in FIG. 10 are, in ascending order of the depth distance, a first layer, a second layer, a third layer, a fourth layer, and a fifth layer corresponding to the depth distance Z1, the depth distance Z2, the depth distance Z3, the depth distance Z4, and the depth distance Z5, respectively.

In each virtual object rendered in the virtual world, depth information indicating a location in the depth direction of the virtual space is set, so that the virtual object is rendered in accordance with the depth information. For example, the depth distance Z1 is set as the depth information to each of the player object PO and the enemy object EO such that the player object PO and the enemy object EO are rendered on the first layer as a two-dimensional image. The player object PO moves on the first layer in accordance with the movement vector Vp calculated based on an operation performed by the user, and a two-dimensional image of a top view of the player object PO with its forward direction (flight direction) facing in the Y-axis positive direction is rendered on the first layer. The enemy object EO moves on the first layer in accordance with the movement vector Ve set based on a predetermined algorithm, and a two-dimensional image of the moving enemy object EO seen from above is rendered on the first layer.

For example, the depth distance Z5 is set as the depth information to each ground objects GO such that the ground objects GO are rendered on the fifth layer as a two-dimensional image. Specifically, a topography object is rendered on the fifth layer, and a two-dimensional image of the ground objects GO seen from above is rendered on the topography object. Each of the ground objects GO which moves on the ground moves on the first layer in accordance with a movement vector set based on a predetermined algorithm, and a two-dimensional image of the moving ground objects GO seen from above is rendered on the first layer.

For example, the depth distance Z2 is set as the depth information to each of the cloud objects CO1, and a two-dimensional image of the cloud objects CO1 are rendered within areas at both edges (a left edge area having a value lower than or equal to a predetermined value in an X-axis negative direction, and a right edge area having a value greater than or equal to the predetermined value in the X-axis positive direction) on the second layer. The depth distance Z3 is set as the depth information to each of the cloud object CO2s, and a two-dimensional image of the cloud objects CO2 are rendered within the areas at both edges on the third layer. The depth distance Z3 is set as the depth information to each of the cloud objects CO3, and a two-dimensional image of the cloud objects CO3 are rendered within the areas at the both edges on the third layer.

When the virtual objects respectively rendered on the first layer to the fifth layer are displayed, a virtual world image for a left eye (left virtual world image) and a virtual world image for a right eye (right virtual world image) are generated based on the respective depth information. For example, an amount of displacement of each layer is calculated based on the camera-to-camera distance calculated based on the position of the slider of the 3D adjustment switch 25, the reference depth distance which coincides with the position of the display screen, and the depth information.

As an example, an amount of displacement at the reference depth distance is set to 0, and an amount of displacement of each layer is set so as to be in a predetermined relationship (direct proportion, for example) with a distance difference between the depth distance of the layer and the reference depth distance. Then, by adding a coefficient based on the camera-to-camera distance to the amount of displacement, the amount of displacement of each layer is determined. Each layer is displaced by the determined amount and is synthesized with the other layers, thereby generating a left virtual world image and a right virtual world image, respectively. For example, when the left virtual world image is generated, a layer at a depth distance longer than the reference depth distance is displaced to the left (in the X-axis negative direction) by the determined amount of displacement, while a layer at a depth distance shorter than the reference depth distance is displaced to the right (in the X-axis positive direction) by the determined amount of displacement. Then, by overlapping the layers with preferentially allocating a layer with a shorter depth distance and synthesizing the layers, the left virtual world image is generated. When the right virtual world image is generated, a layer at a depth distance longer than the reference depth distance is displaced to the right (in the X-axis positive direction) by the determined amount, while a layer at a depth distance shorter than the reference depth distance is displaced to the left (in the X-axis negative direction) by the determined amount. Then, by overlapping the layers on one another with preferentially allocating a layer with a shorter depth distance and synthesizing the layers, the right virtual world image is generated.

The left virtual world image and the right virtual world image which are generated by synthesizing the layers which are respectively set accordingly are displayed on the upper LCD 22, thereby displaying the stereoscopic image of the virtual world as described with reference to FIGS. 5 to 7 on the upper LCD 22. By periodically scrolling each layer in the Y-axis negative direction, the virtual world is displayed while being scrolled in the downward direction of the upper LCD 22. As will be apparent later, an amount of movement by scrolling (amount of scroll) in the Y-axis negative direction is set to a value that changes depending on the depth distance Z at which the virtual object is positioned. For example, the shorter the depth distance Z is, the greater the amount of scroll is set. Specifically, the first layer to the fifth layer are scrolled in the Y-axis negative direction by amounts of scroll S1 to S5, which are set to be S1>S2>S3>S4>S5, respectively.

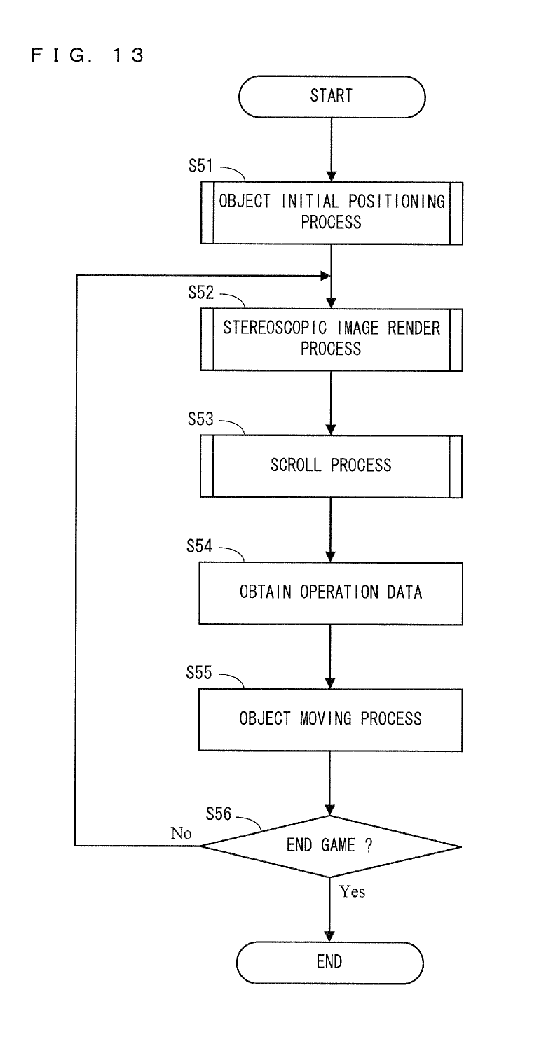

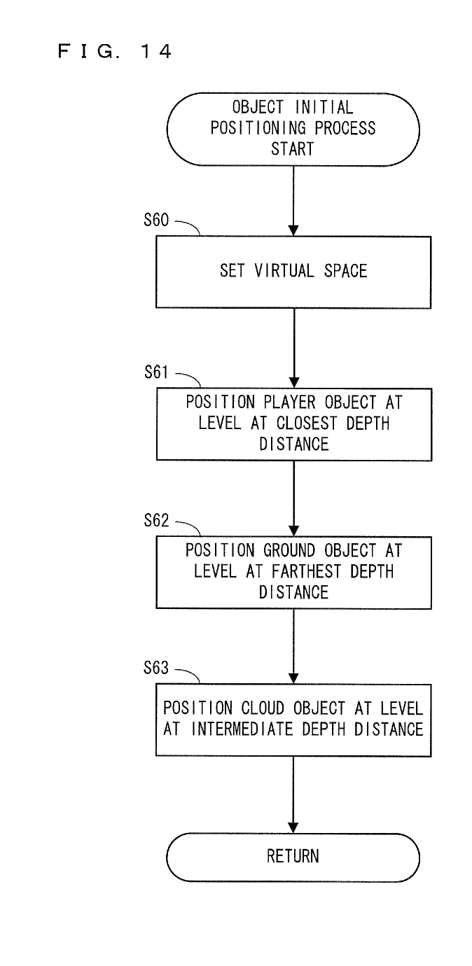

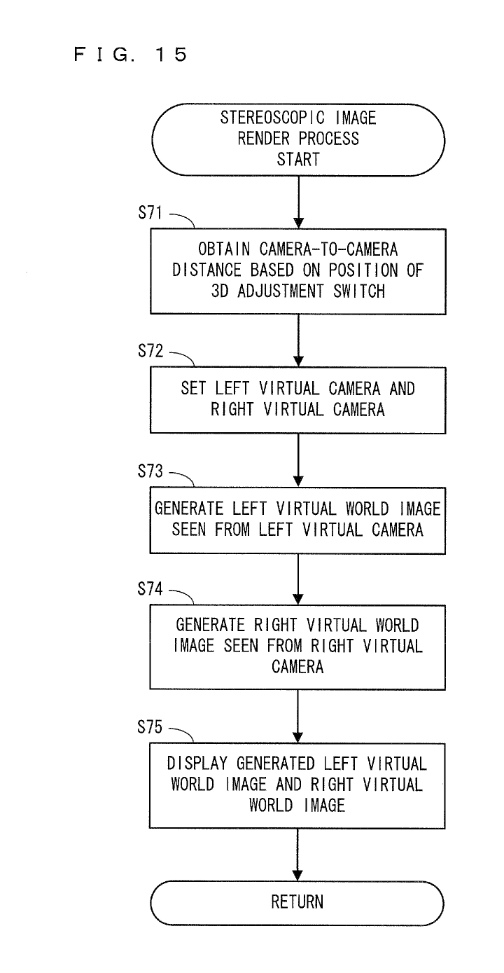

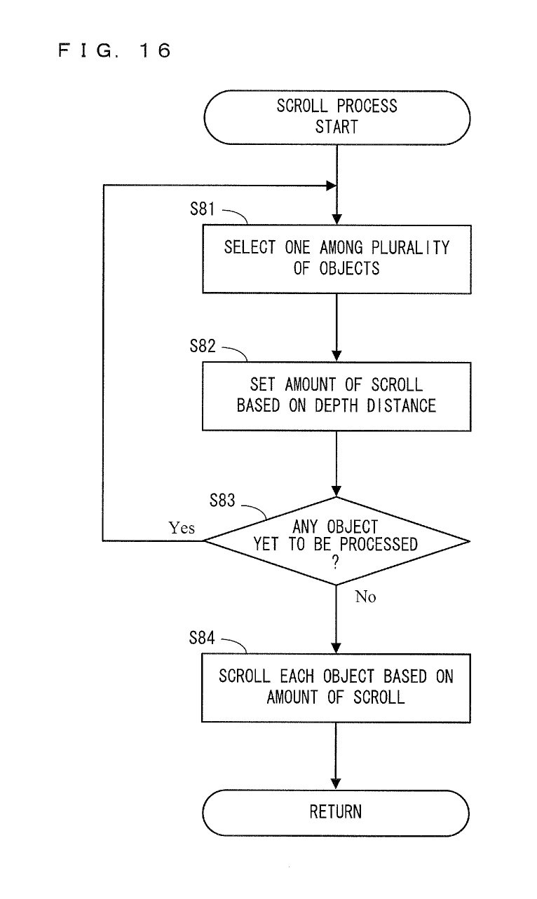

Next, with reference to FIGS. 11 to 16, a specific processing operation based on a display control program executed by the game apparatus 10 will be described. FIG. 11 shows an example of various data stored in the main memory 32 in accordance with a display control program being executed. FIG. 12 shows an example of object data Db in FIG. 11. FIG. 13 is a flow chart showing an example of a display control processing operation performed by the game apparatus 10 executing the display control program. FIG. 14 is a sub-routine showing in detail an example of an object initial positioning process performed in step 51 of FIG. 13. FIG. 15 is a sub-routine showing in detail an example of a stereoscopic image render process performed in step 52 of FIG. 13. FIG. 16 is a sub-routine showing in detail an example of a scroll process performed in step 53 of FIG. 13. It is noted that the program for performing these processes are included in a memory (the internal data storage memory 35, for example) incorporated in the game apparatus 10, the external memory 45, or the external data storage memory 46. When the game apparatus 10 is powered on, the program is loaded into the main memory 32 from an incorporated memory, or from one of the external memory 45 and the external data storage memory 46 via the external memory I/F 33 or the external data storage memory I/F 34, and is executed by the CPU 311. In the following description of the display control processing, a case will be described in which a stereoscopic image is generated by using the first stereoscopic image generation method.

In FIG. 11, the main memory 32 stores therein programs loaded from the incorporated memory, the external memory 45 or the external data storage memory 46; and data which are temporarily generated in the display control processing. As shown in FIG. 11, in a data storage area of the main memory 32, operation data Da, the object data Db, data of camera-to-camera distance Dc, virtual camera data Dd, left virtual world image data De, right virtual world image data Df, image data Dg, and the like are stored. In a program storage area of the main memory 32, a group of various programs Pa which configures the display control program are stored.

The operation data Da indicates operation information of an operation performed onto the game apparatus 10 by the user. For example, the operation data Da includes data indicating operations performed by the user onto an input device such as the touch panel 13, the operation button 14, the analog stick 15, and the like of the game apparatus 10. The operation data from each of the touch panel 13, the operation button 14, and the analog stick 15 is obtained every time unit ( 1/60 sec., for example) of the processing performed by the game apparatus 10. Each time the operation data is obtained, the operation data is stored in the operation data Da and the operation data Da is updated. In a process flow described below, an example is used in which the operation data Da is updated every frame corresponding to a processing cycle; however, the operation data Da may be updated at another cycle. For example, the operation data Da may be updated at another cycle of detecting that the user has operated the input device, and the updated operation data Da may be used for each processing cycle. In this case, the cycle of updating the operation data Da is different from the processing cycle.

The object data Db is data regarding each virtual object which appears in the virtual world. As shown in FIG. 12, the object data Db indicates, with respect to each virtual object, an object type, a location, a movement vector, an amount of scroll, and the like. For example, the object data Db shown in FIG. 12 indicates that the virtual object number 1 is the player object PO; positioned at the depth distance Z1 at an XY position (X1, Y1); moves in the virtual space at the movement vector Vp; and the amount of scroll is set to S1. Further, the object data Db indicates that the virtual object number 4 is the cloud object CO1; fixedly positioned in the virtual space at the depth distance Z2 and at an XY position (X4, Y4); and the amount of scroll is set to S2.

The data of camera-to-camera distance Dc is data indicating a camera-to-camera distance set in accordance with a position of the slider of the 3D adjustment switch 25. For example, the 3D adjustment switch 25 outputs data indicating the position of the slider at a predetermined cycle, and based on the data, the camera-to-camera distance is calculated at the predetermined cycle. In the data of camera-to-camera distance Dc, data indicating the calculated camera-to-camera distance is stored, and the data of camera-to-camera distance Dc is updated every time unit of the processing performed by the game apparatus 10. In a process flow described below, an example is used in which the data of camera-to-camera distance Dc is updated every frame corresponding to the processing cycle; however, the data of camera-to-camera distance Dc may be updated at another cycle. For example, the data of camera-to-camera distance Dc may be updated at a predetermined calculating cycle at which the camera-to-camera distance is calculated, and the data of camera-to-camera distance Dc may be used for each processing cycle of the game apparatus 10. In this case, the cycle of updating the data of camera-to-camera distance Dc is different from the processing cycle.

The virtual camera data Dd is set based on the camera-to-camera distance, and indicates a position and a posture in the virtual space, a projection method, and a display range (view volume; see FIG. 9) of each of the left virtual camera and the right virtual camera. As one example, the virtual camera data Dd indicates a camera matrix of each of the left virtual camera and the right virtual camera. For example, the matrix is a coordinate transformation matrix for transforming, based on the set projection method and the display range, coordinates represented by a coordinate system (world coordinate system) in which each virtual camera is arranged, into a coordinate system (camera coordinate system) defined based on the position and the posture of each of the left virtual camera and the right virtual camera.

The left virtual world image data De indicates an image of a virtual space (left virtual world image) seen from the left virtual camera, in which each virtual object is positioned. For example, the left virtual world image data De indicates the left virtual world image obtained by perspectively projecting the virtual space seen from the left virtual camera in which each virtual object is positioned or by projecting the virtual space in parallel.

The right virtual world image data Df indicates an image of a virtual space (right virtual world image) seen from the right virtual camera, in which each virtual object is positioned. For example, the right virtual world image data Df indicates the right virtual world image obtained by perspectively projecting the virtual space seen from the right virtual camera in which each virtual object is positioned or by projecting the virtual space in parallel.

The image data Dg is information for displaying the above described virtual objects (including the topography object), and includes 3D model data (polygon data) indicating the shape of each virtual object, texture data indicating a pattern of the virtual object, and the like.

Next, with reference to FIG. 13, operations performed by the information processing section 31 will be described. First, when the power supply (power button 14F) of the game apparatus 10 is turned on, a boot program (not shown) is executed by the CPU 311, whereby the program stored in the incorporated memory, the external memory 45, or the external data storage memory 46 is loaded to the main memory 32. Then, the loaded program is executed in the information processing section 31 (CPU 311), whereby steps shown in FIG. 13 (each step is abbreviated as “S” in FIG. 13 to FIG. 16) are performed. In FIG. 13 to FIG. 16, description of processes not directly relevant to the present invention will be omitted. In the present embodiment, processes of all the steps in the flow charts in FIG. 13 to FIG. 16 are performed by the CPU 311. However, processes of some steps in the flow charts in FIG. 13 to FIG. 16 may be performed by a processor other than the CPU 311 or a dedicated circuit.

In FIG. 13, the CPU 311 performs the object initial positioning process (step 51), and proceeds the processing to the next step. In the following, with reference to FIG. 14, the object initial positioning process performed in step 51 will be described.

In FIG. 14, the CPU 311 sets a virtual space in which the left virtual camera and the right virtual camera are arranged (step 60), and proceeds the processing to the next step. For example, the CPU 311 sets a virtual space such that a predetermined distance (0, for example) is provided between the left virtual camera and the right virtual camera; and a view line direction and up/down and left/right directions of the left virtual camera coincides with those of the right virtual camera. Then, the CPU 311 defines a camera coordinate system in which the view line direction of each virtual camera is set as the Z-axis positive direction; the rightward direction of each virtual camera facing in the Z-axis positive direction is set as the X-axis positive direction; and the upward direction of each virtual camera is set as the Y-axis positive direction. The CPU 311 sets a view volume of each of the left virtual camera and the right virtual camera based on the position in the virtual space, the reference depth distance which coincides with the position of the display screen, the projection method for rendering from the virtual camera, a viewing angle of each virtual camera, and the like. Then, the CPU 311 updates the virtual camera data Dd by using the set data regarding each of the left virtual camera and the right virtual camera.

Next, the CPU 311 positions the player object PO at a level at the shortest depth distance from each virtual camera in the virtual space (step 61), and proceeds the processing to the next step. For example, as shown in FIG. 8, the CPU 311 positions the player object PO at a position (level) such that the player object PO is at the depth distance Z1 from each of the left virtual camera and the right virtual camera. In this case, the CPU 311 sets a posture of the player object PO such that the top side of the player object PO faces each virtual camera and is facing in the Y-axis positive direction in the camera coordinate system. The CPU 311 positions the player object PO at an initial location set when the game is started, and sets the movement vector Vp of the player object PO to an initial setting value. Then, the CPU 311 updates the object data Db by using set data regarding the player object PO.

Next, the CPU 311 positions the ground objects GO at a level at the farthest depth distance from each virtual camera in the virtual space (step 62), and proceeds the processing to the next step. For example, as shown in FIG. 8, the CPU 311 positions the topography object at a position (level) such that the topography object is at the depth distance Z5 from each of the left virtual camera and the right virtual camera, and positions the ground objects GO on the topography object. Then, the CPU 311 updates the object data Db by using the set data regarding the ground objects GO. The CPU 311 positions the ground objects GO on the topography object other than an area corresponding to the both edges of the display area opposite to each other along the scroll direction in the virtual space. Accordingly, the ground objects GO are positioned at positions other than the area corresponding to the both edges, thereby preventing the cloud objects CO positioned in the air from hiding the ground objects GO from view.

Next, the CPU 311 positions the cloud objects CO at a level at an intermediate depth distance from each virtual camera in the virtual space (step 63), and ends the processing of the sub-routine. For example, as shown in FIG. 8, the CPU 311 positions the cloud objects CO1 at a position (level) at the depth distance Z2 from each of the left virtual camera and the right virtual camera. In this case, the CPU 311 positions the cloud objects CO1 at the both edges (positions which correspond to both edges of the display area opposite to each other along the scroll direction; and which are at the left edge and the right edge in the view volume of each of the left virtual camera and the right virtual camera when the scroll direction in the virtual space is the up-down direction of the upper LCD 22) in the view volume of each of the left virtual camera and the right virtual camera such that the cloud objects CO1 extend in the scroll direction. The CPU 311 positions the cloud objects CO2 at a position (level) at the depth distance Z3 from each of the left virtual camera and the right virtual camera. In this case, the CPU 311 positions the cloud objects CO2 so as to extend in the scroll direction at the both edges in the view volume of each of the left virtual camera and the right virtual camera. Further, the CPU 311 positions the cloud objects CO3 at a position (level) at the depth distance Z4 from each of the left virtual camera and the right virtual camera. In this case, the CPU 311 positions the cloud objects CO3 so as to extend in the scroll direction at the both edges in the view volume of each of the left virtual camera and the right virtual camera. Then, the CPU 311 updates the object data Db by using the set data regarding the cloud objects CO1 to CO3.

Return to FIG. 13, after the object initial positioning process in step 51, the CPU 311 performs the stereoscopic image render process (step 52), and proceeds the processing to the next step. In the following, with reference to FIG. 15, the stereoscopic image render process performed in step 52 will be described.

In FIG. 15, the CPU 311 obtains a camera-to-camera distance (step 71), and proceeds the processing to the next step. For example, the CPU 311 obtains data indicating a camera-to-camera distance calculated based on the position of the slider of the 3D adjustment switch 25, and updates the data of camera-to-camera distance Dc by using the obtained camera-to-camera distance.

Next, the CPU 311 sets each of the left virtual camera and the right virtual camera in the virtual space based on the camera-to-camera distance obtained in step 71 (step 72), and proceeds the processing to the next step. For example, the CPU 311 sets the positions of the virtual cameras, respectively, such that the camera-to-camera distance obtained in step 71 is provided therebetween, and sets a view volume for each virtual camera. Then, based on the set position and the view volume of each of the left virtual camera and the right virtual camera, the CPU 311 updates the virtual camera data Dd.

Next, the CPU 311 generates the virtual space seen from the left virtual camera as a left virtual world image (step 73), and proceeds the processing to the next step. For example, the CPU 311 sets a view matrix of the left virtual camera based on the virtual camera data Dd; renders each virtual object present in the view volume of the left virtual camera to generate the left virtual world image; and updates the left virtual world image data De.

Next, the CPU 311 generates the virtual space seen from the right virtual camera as a right virtual world image (step 74), and proceeds the processing to the next step. For example, the CPU 311 sets a view matrix of the right virtual camera based on the virtual camera data Dd; renders each virtual object present in the view volume of the left virtual camera to generate the right virtual world image; and updates the right virtual world image data Df.

Next, the CPU 311 displays, as a stereoscopic image, the left virtual world image and the right virtual world image as an image for a left eye and an image for a right eye, respectively on the upper LCD 22 (step 75), and ends the processing of the sub-routine.

Return to FIG. 13, after the stereoscopic image render process in step 52, the CPU 311 performs the scroll process (step 53), and proceeds the processing to the next step. In the following, with reference to FIG. 16, the scroll process performed in step 53 will be described.

In FIG. 16, the CPU 311 selects one of the virtual objects positioned in the virtual space (step 81), and proceeds the processing to the next step.

Next, the CPU 311 sets an amount of scroll based on the depth distance at which the virtual object selected in step 81 is positioned (step 82), and proceeds the processing to the next step. For example, by referring to the object data Db, the CPU 311 extracts the depth distance Z at which the virtual object selected in step 81 is positioned. Then, the CPU 311 sets the amount of scroll corresponding to the extracted depth distance Z such that the shorter the depth distance Z is, the greater the amount of scroll becomes, and updates the object data Db by using the set amount of scroll.

It is noted that, when the virtual object with respect to which the depth distance Z is fixed in step 81 and the amount of scroll is already set, the amount of scroll with respect to the virtual object may not be necessarily reset during the process in step 82.

Further, when the virtual object with respect to which the depth distance Z is set so as to change in step 81, the amount of scroll with respect to the virtual object may be fixed to the value initially set, and may not be reset during the process in step 82. As one example, when the player object PO discharges a ground attack bomb for attacking each ground object GO, a virtual object corresponding to the ground attack bomb moves in the virtual space such that the depth distance Z gradually increases. With respect to the movement of the virtual object corresponding to such a ground attack bomb, even when the depth distance Z changes, by fixing the amount of scroll to the amount of scroll at a firing point, the moving speed of the ground attack bomb displayed on the upper LCD 22 becomes constant if the moving speed of the ground attack bomb in the virtual space is constant. Thus, the user operating the player object PO can easily attack each ground object GO with the ground attack bomb.

As another example, when each ground object GO discharges an air attack bomb for attacking the player object PO, a virtual object corresponding to the air attack bomb moves in the virtual space such that the depth distance Z gradually decreases. With respect to the movement of the virtual object corresponding to such an air attack bomb, even when the depth distance Z changes, by fixing the amount of scroll to the amount of scroll at a firing point, the moving speed of the air attack bomb displayed on the upper LCD 22 becomes constant if the moving speed of the air attack bomb in the virtual space is constant. Thus, the user operating the player object PO can easily understand a trajectory of the air attack bomb discharged from the ground object GO.

Meanwhile, when the virtual object with respect to which the depth distance Z is set so as to change in step 81, the amount of scroll with respect to the virtual object may be changed sequentially in accordance with the change of the depth distance Z, thereby resetting the amount of scroll during the process in step 82. In this case, in the previous example, when the player object PO discharges a ground attack bomb forward, even if the moving speed of the ground attack bomb in the virtual space is constant, the ground attack bomb is displayed such that the moving speed gradually decreases on the upper LCD 22. In the latter example, when the ground object GO discharges an air attack bomb from the front side of the player object PO, even if the moving speed of the air attack bomb in the virtual space is constant, the air attack bomb is displayed such that the speed of the gradually increases on the upper LCD 22.

Next, the CPU 311 determines whether there is any virtual object with respect to which the processes in step 81 and step 82 are yet to be performed (step 83). When there is a virtual object with respect to which the processes are yet to be performed, the CPU 311 returns to step 81 and repeats the processing. On the other hand, when the processes have been processed with respect to all of the virtual objects, the CPU 311 proceeds the processing to step 84.

In step 84, the CPU 311 scrolls each virtual object in a predetermined scroll direction by the set amount of scroll, and ends the processing of the sub-routine. For example, with referring to the object data Db, the CPU 311 scrolls in the Y-axis negative direction each virtual object by the set amount of scroll, and updates an XY position of each virtual object using the location of the virtual space after having been moved.

Return to FIG. 13, after the scroll process in step 53, the CPU 311 obtains the operation data (step 54), and proceeds the processing to the next step. For example, the CPU 311 obtains data indicating operations performed onto the touch panel 13, the operation button 14, and the analog stick 15; and updates the operation data Da.

Next, the CPU 311 performs an object moving process (step 55), and proceeds the processing to the next step. For example, the CPU 311 performs processes such as: updating the movement vector set for each virtual object in step 55; moving each virtual object in the virtual space based on the updated movement vector: causing the virtual object having collided with another virtual object to disappear from the virtual space; causing a new virtual object to appear in the virtual space; and the like.

In the process of updating the movement vector set for each virtual object, based on the movement vector Vp of the player object PO set in the object data Db; and the operation information indicated by the operation data Da, the CPU 311 changes the movement vector Vp and updates the object data Db. For example, when the operation information indicates that the operation button 14A has been pressed, the CPU 311 changes the movement vector Vp of the player object PO so that the player object PO is displayed on the upper LCD 22 while having been moved in a direction instructed by the operation button being pressed in the display range of the upper LCD 22. The CPU 311 changes the movement vector Ve of the enemy object EO and a movement vector Vg of each ground object GO set in the object data Db based on a predetermined algorithm; and updates the object data Db.

In the process of moving each virtual object in the virtual space based on the updated movement vector, the CPU 311 moves each virtual object in the virtual space based on the movement vector set in the object data Db. Then, the CPU 311 updates location data of each virtual object in the object data Db by using the location after the virtual object has been moved. Further, the CPU 311 sets a location of the shooting aim A based on the location of the player object PO after the play object PO has been moved, and positions the shooting aim A at the location. For example, the shooting aim A is positioned a predetermined distance ahead of the player object PO, and at a position on the topography object.

In the process of causing the virtual object having collided with another virtual object to disappear from the virtual space, the CPU 311 extracts a virtual object colliding with another virtual object in the virtual space based on the location data (depth distance, XY position) of each virtual object set in the object data Db. Then, the CPU 311 deletes from the object data Db the virtual object (for example, the player object PO, the enemy object EO, the ground objects GO, an object corresponding to the air attack bomb or the ground attack bomb, and the like) which disappears in case of a collision with another virtual object, thereby causing the virtual object to disappear from the virtual world.

In the process of causing a new virtual object to appear in the virtual space, the CPU 311 causes, based on an operation by the user or a predetermined algorithm, the enemy object EO, the ground objects GO, the air attack bomb, the object corresponding to the ground attack bomb, and the like to newly appear in the virtual space. For example, when the user performs an attack operation such as discharging an air attack bomb or a ground attack bomb, the CPU 311 causes a virtual object corresponding to the attack operation to appear in the virtual space. Further, when the enemy object EO or each ground object GO performs a motion of attacking the player object PO based on the predetermined algorithm, the CPU 311 causes a virtual object corresponding to the attack motion to appear in the virtual space. Specifically, when the CPU 311 causes a virtual object corresponding to an attack operation or an attack motion to appear in the virtual space, the CPU 311 sets, as appearance positions, locations of the player object PO, the enemy object EO, and each ground object GO which perform an attack motion; sets a predetermined moving speed whose moving direction is a forward direction of the player object PO, a direction toward the location of the shooting aim A, a direction toward the location of the player object PO, and the like as a movement vector; and adds data regarding the virtual object to be caused to newly appear to the object data Db. Further, when the CPU 311 causes the enemy object EO and each ground object GO to appear in the virtual space based on the predetermined algorithm, the CPU 311 causes each of the virtual objects to appear in the virtual space in accordance with an appearance position and a movement vector instructed by the algorithm. Specifically, when the CPU 311 causes each of the enemy object EO and the ground objects GO to appear in the virtual space, the CPU 311 sets the appearance position and the movement vector instructed by the algorithm as a location and a movement vector of the virtual object to be caused to newly appear, and adds the data regarding each virtual object to be caused to newly appear to the object data Db. It is noted that when the CPU 311 causes the ground objects GO to newly appear, the CPU 311 causes the ground objects GO to appear on the topography object other than the both edges of the display area opposite to each other along the scroll direction in the virtual space.

Next, the CPU 311 determines whether to end the game (step 56). For example, the CPU determines to end the game, for example, when a condition for game over is satisfied; a condition for clearing the game is satisfied; or the user performs an operation to end the game. When the CPU 311 determines not to end the game, the CPU 311 returns to step 52 and repeats the processing. Meanwhile, when the CPU 311 determines to end the game, the CPU 311 ends the processing of the flow chart.

As described above, in the display control processing according to the above described embodiment, the cloud objects CO1 to CO3 are positioned at a position between the player object PO and the ground objects GO in the depth direction in the stereoscopically displayed virtual world. Accordingly, another virtual object which is interposed between the player object PO and the ground objects GO becomes a comparison target for comparing depth positions, thereby emphasizing a sense of depth between the player object PO and the ground objects GO. Further, when the virtual world is displayed, the cloud objects CO1 to CO3 are always displayed at an edge of the display screen without hiding the player object PO and the ground objects GO from view or disrupting the game play, thereby always keeping sight of the player object PO and the ground objects GO. Still further, when the virtual world is stereoscopically displayed on a display device, the virtual world is scroll-displayed such that the shorter a distance in the depth direction in the virtual world is, the greater the amount of scroll becomes, thereby further providing a stereoscopic effect to the stereoscopically displayed virtual world.

In the above described embodiment, the cloud objects CO1 to CO3 consisting of three layers are positioned so as to overlap one another at a position between the player object PO and the ground objects GO in the depth direction in the stereoscopically displayed virtual world. However, the cloud objects CO positioned at the position between the player object PO and the ground objects GO may consist of a single layer, two layers, four or more layers.

Further, in the above described embodiment, the cloud objects CO1 to CO3 are positioned such that the cloud objects CO1 to CO3 are always displayed at an edge of the display screen. However, it is only necessary that the cloud objects CO1 to CO3 are always displayed at least at a part of the edge of the display screen. Further, the cloud objects CO1 to CO3 may be displayed at a position other than the edge of the display screen. For example, the cloud objects CO are scroll-displayed with respect to the display screen, and thus the cloud objects CO which are each about a size that does not hide the ground objects GO from view may pass through the central part of the display screen while being scroll-displayed. Further, the cloud objects CO1 to CO3 may be displayed so as not to be displayed at a part of the edge of the display screen. For example, when the cloud objects CO1 to CO3 are displayed at the left edge and the right edge of the display screen, it is not necessary that the cloud objects CO1 to CO3 are displayed so as to cover the entire left edge and the right edge. That is, the cloud objects CO1 to CO3 may be displayed on the upper LCD 22 such that a part of at least one of the cloud objects CO1 to CO3 is not positioned or displayed (a cloud breaks, for example) at the left edge and the right edge.

In the present invention, in order to emphasize a sense of depth in a stereoscopically displayed virtual world, another virtual object is interposed in the space in which the sense of depth is to be emphasized, thereby providing a comparison target for comparing depth positions and for emphasizing a sense of depth. Accordingly, there are various examples of the virtual object to be interposed as a comparison target. For example, in the above-described embodiment, the example is used where the cloud objects CO1 to CO3 are displayed at the left edge and the right edge of the display screen while the virtual world is scroll-displayed in the up-down direction of the display screen. However, in the present invention, while the virtual world is scroll-displayed in the up-down direction of the display screen, the cloud objects CO1 to CO3 may be always displayed at one of the left edge and the right edge of the display screen.

The sense of depth between the player object PO and the ground objects GO is emphasized by positioning the cloud objects CO which are comparison targets at the position between the player object PO and the ground objects GO; however, the cloud objects CO which are the comparison targets may not be positioned at a level between the two virtual objects. As one example, the player object PO and the ground objects GO are positioned on the topography object, and the cloud objects CO are positioned in the air above the topography object. In this case, there is no other virtual object in the air further above the cloud objects CO, and thus the level at which the cloud objects CO are positioned is not between the two virtual objects. However, by positioning the cloud objects CO above the player object PO and the ground objects GO, the cloud objects CO become the comparison targets with respect to the depth direction, thereby emphasizing the sense of depth with respect to the player object PO, the ground object GO, and the topography object in the stereoscopically displayed virtual world. As another example, the player object PO and the enemy object EO are positioned at a level (level of the depth distance Z1, for example) at the shortest depth distance, and the cloud objects CO are positioned at a level (level at which the depth distance is relatively long in the depth direction) below the player object PO and the enemy object EO. In this case, there is no other virtual object at a level further below the cloud objects CO, and thus the level at which the cloud objects CO are positioned is not between the two virtual objects. However, by positioning the cloud objects CO behind (at a lower layer) the player object PO and/or the enemy object EO, the cloud objects CO become the comparison targets in the depth direction, thereby emphasizing the sense of depth with respect to the player object PO and/or the enemy object BO in the stereoscopically displayed virtual world.

Further, the present invention is also applicable to a case where the virtual world is scroll-displayed in another scroll direction, and a case where the virtual world is not scrolled. For example, when the virtual world is scroll-displayed in a left-right direction of the display screen, by displaying the cloud objects CO1 to CO3 at least one of an upper edge and a lower edge of the display screen, the same effect can be achieved. Alternatively, when the virtual world is fixedly displayed on the display screen, by always displaying the cloud objects CO1 to CO3 at one of the upper edge, the lower edge, the left edge, and the right edge of the display screen, the same effect can be achieved. For example, when the player object is positioned in the air above the topography object at a depth distance different from that of the topography object and is stereoscopically displayed; and the topography object is fixedly displayed with respect to the display screen, another virtual object such as the cloud objects CO may be displayed at the edge in accordance with the depth distance at which the topography object is displayed at the edge of the display screen. As one example, when a sloping topography object is displayed on the display screen; and the depth distance at a position at the upper edge of the display screen where the topography object is displayed is longer than at other positions, another virtual object (a cloud object, for example) is positioned only at the upper edge between the levels at which the topography object and the player object are positioned, respectively. Accordingly, another virtual object is interposed at a position above the topography object in the depth direction in the stereoscopically displayed virtual world and becomes a comparison target for comparing the depth positions, thereby emphasizing the sense of depth of the topography object.

Further, in the above-described embodiment, the player object PO and the enemy object EO are positioned at the level at the shortest depth distance, the ground objects GO are positioned at the level at the longest depth distance, and the cloud objects CO are positioned at the intermediate level. However, another virtual object may be caused to appear at another level. For example, another level is provided between the level at which the cloud objects CO are positioned and the level at which the ground objects GO are positioned, and another enemy object may appear on the level.

Still further, in the above embodiment, as an example, the view volume of each of the left virtual camera and the right virtual camera may be set in accordance with the display range of the upper LCD 22 (that is, the virtual space in the view volume is entirely displayed on the upper LCD 22); however, the view volume may set by using another method. For example, the view volume of each of the left virtual camera and the right virtual camera may be set regardless of the display range of the upper LCD 22. In this case, in step 75, a part of the left virtual world image representing the virtual space in the view volume of the left virtual camera is cut off and generated as an image for a left eye, and a part of the right virtual world image representing the virtual space in the view volume of the right virtual camera is cut off and generated as an image for a right eye. Specifically, each of the parts of left virtual world image and the right virtual world image is cut off such that, the display range of the virtual space of the image for a left eye coincides with the display range of the virtual space of the image for a right eye at the reference depth distance which coincides with the position of the display screen when the stereoscopic image is displayed on the display screen. Accordingly, the view volume of each of the left virtual camera and the right virtual camera is set so as to be larger than the display area actually displayed on the display screen, and when an image is displayed on the display screen, a range appropriate for stereoscopic display may be cut off from the image in the view volume. In this case, the cloud objects CO1 to CO3 displayed at the edge of the display screen may be positioned in the virtual space such that the cloud objects CO1 to CO3 are displayed at positions which are assumed to be edges of the display range to be cut off in the subsequent process.

In the above described embodiment, the upper LCD 22 is a liquid crystal display of a parallax barrier type, and control of turning ON/OFF of the parallax barrier can switch between a stereoscopic display and a planar display. In another embodiment, for example, the upper LCD 22 of a lenticular lens type liquid crystal display may be used for displaying a stereoscopic image and a planar image. In the case of the lenticular lens type liquid crystal display also, by dividing each of two images taken by the outer imaging section 23 into rectangle shaped images in the vertical direction and alternately aligning the rectangle shaped images, the images are stereoscopically displayed. Even in the case of the lenticular lens type display device, by causing the left and right eyes of the user to view one image taken by the inner imaging section 24, it is possible to display the image in a planar manner. That is, even with a liquid crystal display device of a lenticular lens type, it is possible to cause the left and right eyes of the user to view the same image by dividing the same image into rectangle-shaped images in the vertical direction and alternately aligning the rectangle-shaped images. Accordingly, it is possible to display the image taken by the inner imaging section 24 as a planar image.

In the above, description has been given of an exemplary case where the upper LCD 22 is a display device capable of displaying an image which is stereoscopically visible by naked eyes. However, the upper LCD 22 may be configured by using another method in such a manner as to display an image in a stereoscopically visible manner. For example, the upper LCD 22 may be configured such that it can display an image in a stereoscopically visible manner by using polarizing filter method, time sharing system, anaglyph method, or the like.

In the embodiment, description has been given of a case where the lower LCD 12 and the upper LCD 22, which are physically separated components and vertically aligned, are used as an example of the liquid crystal display corresponding to two screens (the two screens are vertically aligned). However, the present invention can be realized by an apparatus including a single display screen (e.g., the upper LCD 22 only) or an apparatus which performs image processing onto an image to be displayed on a single display device. Alternatively, the configuration of the display screen corresponding to two screens may be realized by another configuration. For example, the lower LCD 12 and the upper LCD 22 may be arranged on one main surface of the lower housing 11, such that they are arranged side by side in the horizontal direction. Still alternatively, one vertically long LCD which has the same horizontal dimension as that of the lower LCD 12 and has a longitudinal dimension twice of that of the lower LCD 12 (that is, physically one LCD having a display area corresponding to two screens which are vertically arranged) may be provided on one main surface of the lower housing 11, and two images (e.g., an taken image, an image of a screen indicating operational descriptions, and the like) mat be vertically displayed (that is, the two images are displayed vertically side by side without the border portion therebetween). Still alternatively, one horizontally long LCD which has the same longitudinal dimension as that of the lower LCD 12 and has a horizontal dimension twice of that of the lower LCD 12 mat be provided on one main surface of the lower housing 11, and two images mat be horizontally displayed (that is, the two images are displayed horizontally side by side without the border portion therebetween). That is, by dividing one screen into two display portions, two images may be displayed on the display portions, respectively. Yet alternatively, when the two images are displayed on the two display portions provided on the physically one screen, the touch panel 13 may be provided in such a manner as to cover the entire screen.

In the embodiment described above, the touch panel 13 is provided integrally with the game apparatus 10. However, it is understood that the present invention can be realized even when the touch panel is provided separately from the game apparatus. Still alternatively, the touch panel 13 may be provided on the surface of the upper LCD 22, and the display image displayed on the lower LCD 12 may be displayed on the upper LCD 22, and the display image displayed on the upper LCD 22 may be displayed on the lower LCD 12. Yet alternatively, the touch panel 13 may not be provided when realizing the present invention.

The embodiment has been described by using the hand-held game apparatus 10; however, the display control program of the present invention may be executed by using an information processing apparatus such as a stationary game apparatus or a general personal computer, to realize the present invention. In another embodiment, instead of the game apparatus, any hand-held electronic device, such as PDA (Personal Digital Assistant) or a mobile telephone, a personal computer, a camera, or the like may be used.

In the above, description has been given of an exemplary case where the display control processing is performed by the game apparatus 10. However, at least a part of the process steps in the display control processing may be performed by other apparatuses. For example, when the game apparatus 10 is allowed to communicate with another apparatus (for example, server or another game apparatus), the process steps in the display control processing may be performed by the game apparatus 10 in combination with the other apparatus. As an example, the game apparatus 10 may perform the processes of: transmitting operation data to another apparatus; receiving a left virtual world image and a right virtual world image generated by the other apparatus; and stereoscopically displaying the received images on the upper LCD 22. In this manner, also when at least a part of the process steps in the above display control processing is performed by the other apparatus, the processing similar to the above described display control processing can be performed. The above described display control processing can be performed by one processor or by a cooperation of a plurality of processors included in an information processing system formed by at least one information processing apparatus. In the above embodiment, the processes in the above flow charts are performed by the information processing section 31 of the game apparatus 10 performing a predetermined program. However, a part or the whole of the above processes may be performed by a dedicated circuit included in the game apparatus 10.

In addition, the shape of the game apparatus 10 is only an example. The shapes and the number of the various operation buttons 14, the analog stick 15, and the touch panel 13 are examples only, and the positions at which the various operation buttons 14, the analog stick 15, and the touch panel 13 are mounted, respectively, are also examples only. It is understood that other shapes, other number, or other positions may be used for realizing the present invention. The order of the process steps, the setting values, the values used for determinations, and the like which are used in the display control processing described above are only examples. It is understood that other order of process steps and other values may be used for realizing the present invention.

Furthermore, the display control program (game program) may be supplied to the game apparatus 10 not only via an external storage medium such as the external memory 45 or the external data storage memory 46, but also via a wired or wireless communication line. Furthermore, the program may be stored in advance in a nonvolatile storage unit in the game apparatus 10. The information storage medium for storing the program may be a CD-ROM, a DVD, a like optical disc-shaped storage medium, a flexible disc, a hard disk, a magneto-optical disc, or a magnetic tape, other than a nonvolatile memory. The information storage medium for storing the above program may be a volatile memory for storing the program.

While the invention has been described in detail, the foregoing description is in all aspects illustrative and not restrictive. It should be understood that numerous other modifications and variations can be devised without departing from the scope of the invention. It should be understood that the scope of the present invention is interpreted only by the scope of the claims. Further, throughout the specification, it should be understood that terms in singular form include a concept of plurality. Thus, it should be understood that articles or adjectives indicating the singular form (e.g., “a”, “an”, “the”, and the like in English) includes the concept of plurality unless otherwise specified. It also should be understood that, from the description of specific embodiments of the present invention, the one skilled in the art is able to easily implement the present invention in the equivalent range based on the description of the present invention and on the common technological knowledge. Further, it should be understood that terms used in the present specification have meanings generally used in the art concerned unless otherwise specified. Therefore, unless otherwise defined, all the jargons and technical terms have the same meanings as those generally understood by one skilled in the art of the present invention. In the event of any confliction, the present specification (including meanings defined herein) has priority.

The storage medium having stored therein the display control program, the display control apparatus, the display control system, and the display control method according to the present invention is able to emphasize a sense of depth when displaying a stereoscopically visible image, and are useful as a display control program, a display control apparatus, a display control system, and a display control method which perform processing for displaying various stereoscopically visible images on a display device.

What is claimed is:

1. A computer-readable storage medium having stored therein a display control program, the display control program causing a computer of a display control apparatus which outputs a stereoscopically visible image to function as
object positioning means for positioning a first object at a position at a first depth distance in a depth direction in a virtual world,
stereoscopic image output control means for outputting as a stereoscopic image an object in the virtual world positioned by the object positioning means, and
the object positioning means positioning at least one second object: at a position at a depth distance which is different from the first depth distance in the depth direction in the virtual world; and in a manner such that the second object is displayed on at least a part of a display area corresponding to an edge of a display device when the second object is displayed as the stereoscopic image on the display device.

2. The computer-readable storage medium having stored therein the display control program according to claim 1, wherein
the object positioning means further positions a third object at a position at a second depth distance which is different from the first depth distance in the depth direction in the virtual world, and
the object positioning means positions the second object at a position at a depth distance between the first depth distance and the second depth distance in the depth direction in the virtual world.

3. The computer-readable storage medium having stored therein the display control program according to claim 2, wherein the object positioning means positions the second object in a manner such that the second object is displayed on only the part of the display area corresponding to the edge of the display device.

4. The computer-readable storage medium having stored therein the display control program according to claim 2, wherein
the second depth distance is longer than the first depth distance, and
the object positioning means positions the third object in a manner such that the third object does not overlap the second object when the third object is displayed as the stereoscopic image on the display device.

5. The computer-readable storage medium having stored therein the display control program according to claim 2, wherein the object positioning means positions a plurality of the second objects: at a position at the depth distance between the first depth distance and the second depth distance; and in a manner such that the plurality of the second objects are always displayed on at least the part of the display area corresponding to the edge of the display device.

6. The computer-readable storage medium having stored therein the display control program according to claim 5, wherein the object positioning means: positions the plurality of the second objects at positions at different depth distances between the first depth distance and the second depth distance; and displays the plurality of the second objects so as to at least partly overlap one another when the plurality of the second objects are displayed as the stereoscopic image on the display device.

7. The computer-readable storage medium having stored therein the display control program according to claim 2, wherein the object positioning means positions: the first object on a plane set at the first depth distance in the virtual world; a third object on a plane set at the second depth distance in the virtual world; and the second object on at least one plane set at a depth distance between the first depth distance and the second depth distance in the virtual world.

8. The computer-readable storage medium having stored therein the display control program according to claim 2, the display control program further causes the computer to function as:
operation signal obtaining means for obtaining an operation signal corresponding to an operation performed onto an input device; and
first object motion control means for causing the first object to perform a motion in response to the operation signal obtained by the operation signal obtaining means, wherein
the second object is a virtual object which is able to affect a score which the first object obtains in the virtual world and/or a time period during which the first object exists in the virtual world, and
the third object is a virtual object which affects neither the score which the first object obtains in the virtual world nor the time period during which the first object exists in the virtual world.

9. The computer-readable storage medium having stored therein the display control program according to claim 2, wherein
the stereoscopic image output control means outputs the stereoscopic image while scrolling, in a predetermined direction perpendicular to the depth direction, each of the objects positioned by the object positioning means, and
the object positioning means positions the second objects in a manner such that the second objects are always displayed on at least a part of the display area corresponding to both edges of the display device opposite to each other along the predetermined direction when the second objects are displayed as the stereoscopic image on the display device.

10. The computer-readable storage medium having stored therein the display control program according to claim 2, wherein the stereoscopic image output control means outputs the stereoscopic image while scrolling, in the predetermined direction perpendicular to the depth direction, the objects positioned by the object positioning means by different amounts of scroll in accordance with the depth distances.

11. The computer-readable storage medium having stored therein the display control program according to claim 10, wherein the stereoscopic image output control means sets an amount of scroll of the second object so as to be smaller than an amount of scroll of the first object and larger than an amount of scroll of the third object.

12. The computer-readable storage medium having stored therein the display control program according to claim 10, wherein
the object positioning means positions a plurality of the second objects at positions at different depth distances between the first depth distance and the second depth distance, and
the stereoscopic image output control means outputs the stereoscopic image while scrolling, in a predetermined direction, the plurality of the second objects by different amounts of scroll in accordance with the depth distances.

13. The computer-readable storage medium having stored therein the display control program according to claim 10, wherein the stereoscopic image output control means outputs the stereoscopic image, while scrolling each of the objects positioned by the object positioning means, in a manner such that the longer the depth distance is, the smaller an amount of scroll becomes.

14. The computer-readable storage medium having stored therein the display control program according to claim 2, wherein
the display control program further causes the computer to function as:
operation signal obtaining means for obtaining an operation signal corresponding to an operation performed onto an input device; and
first object motion control means for causing the first object to perform a motion in response to an operation signal obtained by the operation signal obtaining means, and
the second depth distance is longer than the first depth distance.

15. The computer-readable storage medium having stored therein the display control program according to claim 1, wherein the object positioning means positions the second object at a position at a depth distance which is shorter than the first depth distance in the depth direction in the virtual world.

16. A display control apparatus which outputs a stereoscopically visible image comprising
object positioning means for positioning a first object at a position at a first depth distance in a depth direction in a virtual world,
stereoscopic image output control means for outputting as a stereoscopic image an object in the virtual world positioned by the object positioning means, and
the object positioning means positioning at least one second object: at a position at a depth distance which is different from the first depth distance in the depth direction in the virtual world; and in a manner such that the second object is displayed on at least a part of a display area corresponding to an edge of a display device when the second object is displayed as the stereoscopic image on the display device.

17. A display control system which includes a plurality of devices communicable with to each other, and outputs a stereoscopically visible image comprising
object positioning means for positioning a first object at a position at a first depth distance in a depth direction in a virtual world,
stereoscopic image output control means for outputting as a stereoscopic image an object in the virtual world positioned by the object positioning means, and
the object positioning means positioning at least one second object: at a position at a depth distance which is different from the first depth distance in the depth direction in the virtual world; and in a manner such that the second object is displayed on at least a part of a display area corresponding to an edge of a display device when the second object is displayed as the stereoscopic image on the display device.

18. A display control method which is executed by one processor or collaboration of a plurality of processors included in a display control system which includes at least one information processing apparatus capable of performing display control for outputting a stereoscopically visible image, the display control method comprising
an object positioning step of positioning a first object at a position at a first depth distance in a depth direction in a virtual world,
a stereoscopic image output controlling step of outputting as a stereoscopic image an object in the virtual world positioned in the object positioning step, and
the object positioning step of positioning at least one second object: at a position at a depth distance which is different from the first depth distance in the depth direction in the virtual world; and in a manner such that the second object is displayed on at least a part of a display area corresponding to an edge of a display device when the second object is displayed as the stereoscopic image on the display device.
